(19) United States
(12) Patent Application Publication
(10) Pub. No.: US 2023/0259898 A1
(43) Pub. Date: Aug. 17, 2023

(54) VIRTUAL CURRENCY BASED ON COMMUNITIES PROVIDING FOR EACH OTHERS NEEDS

(71) Applicant: Shibu Mathai, Lawrenceville, GA (US)

(72) Inventor: Shibu Mathai, Lawrenceville, GA (US)

(21) Appl. No.: 17/670,447

(22) Filed: Feb. 12, 2022

(51) Int. Cl. G06Q 20/06

(52) U.S. Cl. CPC G06Q 20/065

(57) ABSTRACT

There is value that is created when users provide for each other's needs for goods and services. This value that is created when a need is met, can be quantified, and stored as a virtual currency recognized by a group or groups of users (also known as CommunityValue of a community group) and this can be assigned to the user who provided for the need. This store of value in the form of CommunityValue of a community group, can then be exchanged or traded, for goods and services or anything else of value.

### FIELD OF THE INVENTION

The present invention relates to a system that provides a platform for users and groups of users to support each other's needs for goods and services, and where the system also provides the means to create and store the value that is created when a user's need is met in the form of a virtual currency that is recognized by a group or groups of users (which is also known as CommunityValue of a community group) which is then assigned to the user who provided for the need. This store of value in the form of CommunityValue of a community group, can then be exchanged or traded by the users, for goods and services or anything else of value (e.g., a virtual currency).

### BACKGROUND OF THE INVENTION

For communities, consisting of a group of users, who wish to be able to free from repressive mandates placed on them by authoritarian regimes (who could in turn be influenced by other people of influence with vested interests) to implement systems such as, but not limited to, you cannot buy or sell without receiving a medical procedure or without receiving a mark of compliance, it has become necessary for communities to be formed globally and locally, where the users would be able to support each other's needs for goods and services. Furthermore, these communities would need monetary freedom and would need to have the ability to create and store value that is created when a user's need is met, in the form of a virtual currency that would be recognized by a group or groups of users as a store of value that can be exchanged or traded, for goods and services or anything else of value.

Also, one of the drawbacks of traditional forms of money (like fiat, which is backed by a government), in terms of determining value is that it does not consider the worth of the goods and services with respect to a recipient at the time of receiving the goods and services, neither does it consider the condition or state of the recipient at the time of receiving the goods and services. For instance, the worth piece of bread for a man who has been starving for several days is worth much than for the same piece of bread being made available to a person who is well fed. The present invention addresses this by allowing the recipient to specify the value of goods and services received.

Also, with more and more governments adopting policies that enable them to borrow heavily and keep printing fiat currencies, the risk of hyperinflation becomes a very real thing, which could cause people to look around for alternative ways to have their needs for goods and services met other than relying on money in terms of fiat currencies. For instance, people could start using charity, barter or exchanging anything of value (e.g., a virtual currency) to have their need for goods and services to be met.

Also, once certain groups of users start recognizing the virtual currencies that's is created when a user's need is met either through charity, barter or exchanging anything of value; then these virtual currencies start providing a store of value to these users, that can be easily exchanged for goods and services, allowing these users to meet each other's needs reducing their dependence on fiat currencies, or other virtual currencies which are controlled by people outside their group and which could in turn be used by people outside their group to exert control over them.

As with any system, the system proposed here would need to have checks and balances to prevent misuse by users or groups of users, but at the same time provide sufficient control to the users and groups of users to be able to support each other's need for goods and services.

It is with respect to these and other general considerations that the following embodiments have been described. Also, although relatively specific problems have been discussed, the embodiments should not be limited to solving the specific problems identified in the background.

### SUMMARY OF THE INVENTION

The present invention advantageously fills the aforementioned deficiencies by providing an information processing system which provides its users the ability to form groups known as community groups, where the members of each community group (also known as community group members) can provide for each other needs for goods and services within their own group as well as outside their group, all the while creating and storing the value that gets created when a user's need for goods and services is met in the form of a virtual currency, which gets assigned to the user who had provided the goods and services.

In certain embodiments (but not all) of the system the users can choose various options to provide for each other's needs for goods and services, including but not limited by charity, barter or exchanging anything of value (e.g., a virtual currency).

In certain embodiments (but not all) of the system, the system helps users to specify the estimated value for each item of goods and services needed or supplied by them in the form of an estimated CommunityValue before the items are provided to the recipients.

In certain embodiments (but not all) of the system, the system helps the users who have received goods and services, to specify the actual value perceived by them with regards to the goods and services that they have received, in the form of an actual CommunityValue. In certain embodiments (but not all) of the system, the actual CommunityValue is used to create virtual currency belonging to a particular community group (i.e., CommunityValue of a community group) which is then assigned to the user who had provided the goods and services.

In certain embodiments (but not all) of the system can provide the users suggestion, based on various means (e.g., community group configuration, Artificial Intelligence/Machine Learning (AI/ML) models), for helping the users specify the estimated CommunityValue and actual CommunityValue.

In certain embodiments (but not all) of the system may restrict what the user can specify for the estimated CommunityValue and actual Community Value, based on various means for instance (but not limited to), community group configuration, Artificial Intelligence/Machine Learning (AI/ML) models.

In certain embodiments (but not all) the system permits users to exchange messages with regards to goods and services items needed or supplied by the users.

In certain embodiments (but not all) the system permits the users to provide an amount of CommunityValue of a community group that they possess in exchange for goods and services. In certain embodiments (but not all) the system described in the present invention interfaces with other systems that accept CommunityValue of a community group in exchange for goods and services.

In certain embodiments (but not all) the system permits the users to trade CommunityValue of a community group to obtain CommunityValue of another community group.

In certain embodiments (but not all) the system permits conversion of the CommunityValue of a community group held by the user into CommunityValue of another community group, and the system determines the rate of conversion to be used.

In certain embodiments (but not all) a user may be suspended from certain or all activities within a community group.

In certain embodiments (but not all) a user may be suspended from exchanging CommunityValue of a community group for obtaining goods and services.

In certain embodiments (but not all) a user may be suspended from trading CommunityValue of a community group for obtaining CommunityValue of another community group.

In certain embodiments (but not all) suspension of users, from certain or all activities in the system, may be controlled by the admin of the system.

In certain embodiments (but not all) suspension of users may be controlled by Artificial Intelligence/Machine Learning (AI/ML) models.

The information processing system examples are implemented as a computer program, a computer process, a computing system, or as an article of manufacture such as a device, or computer readable medium. According to one aspect, the computer program is a computer storage medium readable by a computer system and encoding a computer program comprising of instructions for executing a computer process.

This summary is provided to introduce a selection of concepts in a simplified form which are further described in the Detailed Description of the Invention section. This summary is not intended to identify all the key features or essential features of the claimed subject matter, nor is it intended to be used to limit the scope of the claimed subject matter.

### BRIEF DESCRIPTION OF THE DRAWINGS

FIG. 1 illustrates an example environment in which some exemplary embodiments of the present disclosure may be practiced, along with an example of users, user groupings, user roles, and kind of users who may be interacting with the environment.

FIG. 2 shows a flow diagram of an exemplary embodiment of the present invention which shows some of the, not all the, operations performed by the system and a charity requestor.

FIG. 3 shows a flow diagram of an exemplary embodiment of the present invention which shows some of the, not all the, operations performed by the system and a charity supplier.

FIG. 4 shows a flow diagram of an exemplary embodiment of the present invention which shows some of the, not all the, operations performed by the system and a barter requestor.

FIG. 5 shows a flow diagram of an exemplary embodiment of the present invention which shows some of the, not all the, operations performed by the system and a barter offer provider.

FIG. 6 shows a flow diagram of an exemplary embodiment of the present invention which shows a possible implementation, not all, of the way estimated CommunityValue could be set for goods and services

FIG. 7 shows a flow diagram of an exemplary embodiment of the present invention which shows a possible implementation, not all, of the way actual CommunityValue could be set for goods and services.

FIG. 8 shows a flow diagram of an exemplary embodiment of the present invention which shows a possible implementation, not all, of the way messages may be exchanged between community group members for charity needs or for charity supplies.

FIG. 9 shows a flow diagram of an exemplary embodiment of the present invention which shows a possible implementation, not all, of the way messages may be exchanged between community group members for barter requests.

FIG. 10 shows a flow diagram of an exemplary embodiment of the present invention which shows a possible implementation, not all, of the way messages may be exchanged between community group members for barter offers.

FIG. 11 shows a flow diagram of an exemplary embodiment of the present invention which shows a possible implementation, not all, of the way messages may be exchanged between community group members, for barter exchanges in which the community group members are involved.

FIG. 12 shows a flow diagram of an exemplary embodiment of the present invention which shows a possible implementation, not all, of the way in a which a user can create a community group.

FIG. 13 shows a flow diagram of an exemplary embodiment of the present invention which shows a possible implementation, not all, of the way in a which an admin of a community group is able to invite users to join the community group.

FIG. 14 shows a flow diagram of an exemplary embodiment of the present invention which shows a possible implementation, not all, of the way in a which a user is able to join a community group by raising a request to join a group.

FIG. 15 shows a flow diagram of an exemplary embodiment of the present invention which shows a possible implementation, not all, of the way in a which a user is able to enter a community group.

FIG. 16 shows a flow diagram of an exemplary embodiment of the present invention which shows a possible implementation, not all, of the way in a which a user is either able to report an incident about a user or about a community group.

FIG. 17 shows a flow diagram of an exemplary embodiment of the present invention which shows a possible implementation, not all, of the way in a which an admin of a community group is able to update the status of community group members with respect to the community group.

FIG. 18 shows a flow diagram of an exemplary embodiment of the present invention which shows a possible implementation, not all, of the way in a which a system admin is able to update the status of a user with respect to the system.

FIG. 19 shows a flow diagram of an exemplary embodiment of the present invention which shows a possible implementation, not all, of the way in a which a system admin is able to update the status of a community group with respect to the system.

FIG. 20 shows a flow diagram of an exemplary embodiment of the present invention which shows a possible implementation, not all, of the way in a which the system prevents actions by users based on the user's and the community group's status (which would already be updated to reflect type of suspensions if any suspension has been applied on them).

FIG. 21 shows a flow diagram of an exemplary embodiment of the present invention which shows a possible implementation, not all, of the way in a which a user who is a provider is able to receive value in terms of CommunityValue of a specific community group for items provided by him.

FIG. 22 shows a flow diagram of an exemplary embodiment of the present invention which shows a possible implementation, not all, of the way in a which a user who is a needer is able to spend value in terms of CommunityValue of a specific community group that he possesses for items that are needed by him.

FIG. 23 shows a flow diagram of an exemplary embodiment of the present invention which shows a possible implementation, not all, of the way in a which the system computes the conversion rate to be used in the conversion process when converting CommunityValue of a community group to the CommunityValue of another community group.

FIG. 24 shows a flow diagram of an exemplary embodiment of the present invention which shows a possible implementation, not all, of the way in a which a user is able to trade the CommunityValue of a community group to obtain the CommunityValue of another community group.

### DETAILED DESCRIPTION OF THE INVENTION

The present invention now will be described more fully hereinafter with reference to the accompanying drawings, which are intended to be read in conjunction with the other sections of this document and amendments to this document if any and any preferred and/or particular embodiments specifically discussed or otherwise disclosed. However, this invention may be embodied in many different forms and should not be construed as limited to the embodiments set forth herein. Instead, these embodiments are provided by way of illustration only and so that this disclosure will be thorough, complete and will fully convey the full scope of the invention to those skilled in the art. Like numbers in the figures refer to like components, which should be apparent from the context of use.

The term CommunityValue of a community group refers to a virtual currency used as a store of value, that is created and assigned to the users who provide for goods and services. This CommunityValue of a community group is recognized as a store of value by the community group members of the community group associated with Community Value, as well as other users of the system. This store of value in the form of CommunityValue of a community group, can be exchanged or traded by the users who possess them for goods and services or anything else of value (e.g., a virtual currency) with other users, who recognize this CommunityValue of the community group as a store of value.

In certain embodiments (but not all) the creation of CommunityValue of a community group is dependent on the recipient of goods and services, who indicates the value perceived by him for the goods and services he received from another user, this amount specified for the perceived value is then used for the creation of CommunityValue of a community group. This allows the users to specify the actual worth of the goods and services that they have received based on their perception, and thereby the creation of CommunityValue of a community group gets linked to the value perception of the recipient for the goods and services received.

The term estimated CommunityValue is used to describe the estimated value perceived by users for goods and services prior to the goods and services being provided to the recipient, while the term actual CommunityValue used to describe the actual value perceived by users, who specify this value after they have received the goods and services.

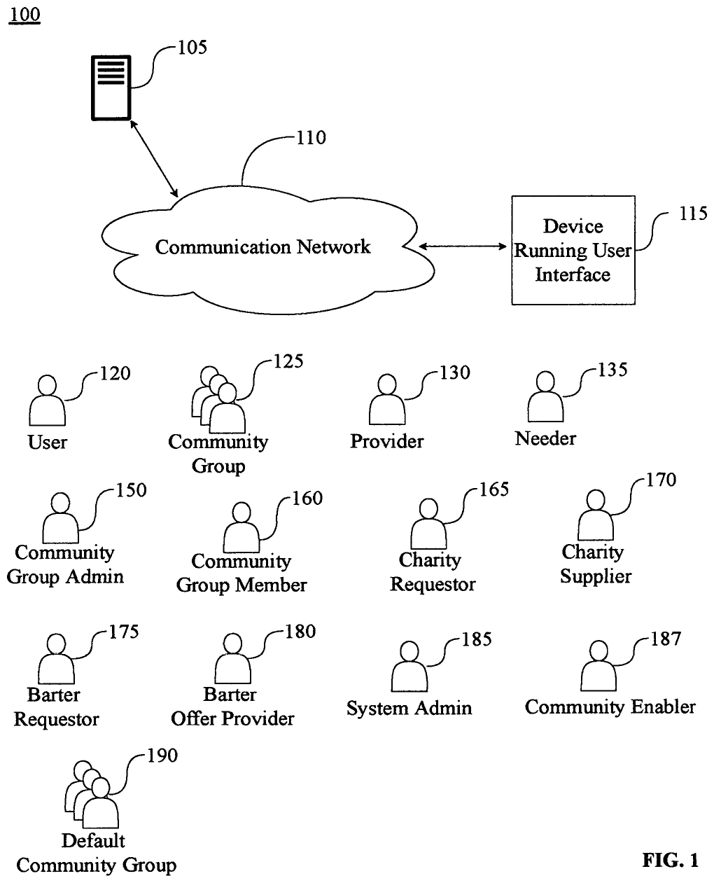

FIG. 1 illustrates an example environment 100 in which some exemplary embodiments of the present disclosure may be practiced. The example environment 100 includes, but is not limited to, at least one of server 105, communication network 110, device running user interface 115.

Server 105 may be at least one of a web server delivering or serving up web page, an application server handling application operations between users and applications or databases, a cloud server, a database server, a file server, a service server, a game server implementing games or services for a game, an content server for storing content information, and a media server delivering media such as streaming video or audio.

Communication network 110 may include any wired or wireless connection, the internet, or any other form of communication. Although one network 110 is identified in FIG. 1, communication network 110 may include any number of different communication networks between any of the server, devices running user interface, resource and system shown in FIG. 1 and/or other servers, devices, resources and systems described herein. Communication network 110 may enable communication between various computing resources or devices, servers, and systems. Various implementations of communication network 110 may employ different types of networks, for example, but not limited to, computer networks, telecommunications networks (e.g., cellular), mobile wireless data networks, and any combination of these and/or other networks.

Device running user interface 115 may include any device capable of running user interface related to the system to make the system accessible to its users, capable of processing and storing data/information and communicating over communication network 110. For example, device running user interface 115 may include personal computers, servers, cell phones, tablets, laptops, smart devices (e.g., smart watches or smart televisions). The device running user interface 115 will be used by the various users of the present invention to interact with the system via interfaces provided by the system, which may include but are not limited by a graphical user interface, mobile apps, web pages.

FIG. 1 also lists an example of users and groups of users that will interact with an exemplary embodiment of the present disclosure. The users include but are not limited to user 120, provider 130, needer 135, community group admin 150, community group member 160, charity requestor 165, charity supplier 170, barter requestor 175, barter offer provider 180, system admin 185, community enabler 187. The groups of users include but are not limited to community group 125, default community group 190.

User 120 is an independent person or person/s representing an organization who can be uniquely identified by the system and who have unique credentials that provide them access to the system.

Community group 125 is any group that is formed within the system by a user 120 with the purpose of creating a group of users 120 (i.e. community group member's 160) who would be interested to provide for each other needs for goods and services, and where the group of users 120 recognize that there is value specific to the group (CommunityValue of their community group 125) that gets created when each other's needs are met and this value is assigned (and accessible) to the user 120 who provided for another user's need. The community group members 160 also recognize that the CommunityValue of their community group 125 which they possess (have access to) can be exchanged for goods and services within the community group 125. The community group members 160 also recognize that the “CommunityValue of their community group 125” can be exchanged for goods and services with users 120 who are not members of their community group 125 if those users 120 recognize it as a store of value and are willing to provide goods and services in exchange for it.

The provider 130, is any user 120 who is capable and willing to provide items of goods and services to other users 120 in exchange for a certain amount of value represented by CommunityValue of a particular community group 125.

The needer 135, is any user 120 who wishes to obtain items of goods and services in exchange for a certain amount of value represented by CommunityValue of a particular community group 125 that he possesses (or that can be obtained by converting the CommunityValue of other community groups 125 that he possesses).

The community group member 160, is any user 120 who was permitted to join a community group 125 (or had created the community group 125) and is a member of a community group 125.

The community group admin 150, is a community group member 160 of a community group 125 who has the role of community administrator and who is authorized to administer the community group 125. The administrative action taken by the community group admin 150 includes but are not limited by, invite/approve users 120 (or persons outside the system) who are not community group members 160 to join the community group 125, specify the role (including but not limited to the role of community group admin 150) to be assigned to members of the community group 125, restrict actions or remove restrictions to perform action by members of the community group 125 within the community group 125.

By default, a user 120 who creates a community group 125 is assigned the role of the community group admin 150 of the community group 125. There should always be at least one community group admin 150 for a community group 125.

The charity requestor 165, is a community group member 160 of a community group 125 who has charity needs for goods and services (i.e., he does not have anything to barter or provide in exchange for the goods and services) which he hopes will be supplied by other community group members 160 of his community group 125.

The charity supplier 170, is a community group member 160 of a community group 125 who has goods and services available as charity supplies (i.e., he does not expect anything in return or in exchange for the goods and services be provides) and who provides the community group members 160 of his community group 125 access to these supplies.

The barter requestor 175, is a community group member 160 of a community group 125 who has goods and services available for barter, and who would like something in return from the community group members 160 of his community group 125.

The barter offer provider 180, is a community group member 160 of a community group 125 who responds to a barter request created by a barter requestor 175 within his community group 125, with an offer to provide goods and services in return for the goods and services being traded by the barter requestor 175.

The system admin 185, is any user 120 with the role of system administrator who is authorized to administer the system and who oversees the activities of the various users 120 and community groups 125 to ensure that the terms and conditions for using the system are met. The system admin 185 also is able to assign the role of system admin 185 to other users 120 of the system. The system admin 185 also acts as the community group admin 150 of the default community group 190.

In certain embodiments (but not all) the community enabler 187, is a single user 120 who is responsible for ensuring that the system is available for access to the users. In certain embodiments (but not all) the community enabler 187 is by default a community group member 160 of all community group 125 and cannot be suspended by the system admins 185 or the community group admins 150.

In certain embodiments (but not all) the default community group 190, is a community group 125 that all users 120 of the system are a member of by default.

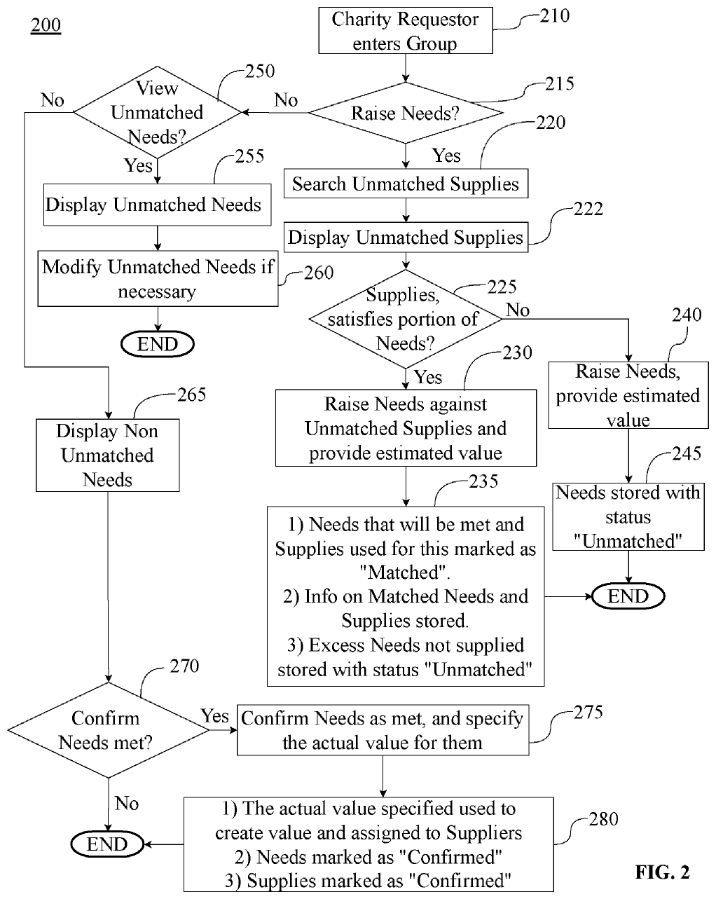

FIG. 2 shows a flow diagram of an exemplary embodiment 200 of the present invention which shows some of the, not all the, operations performed by the system and a charity requestor 165.

At operation 210, a charity requestor 165 enters a community group 125 in which he is a community group member 160.

At operation 215, the charity requestor 165 decides if he wants to raise his charity needs for goods and services within the community group 125 or not. If the charity requestor 165 wants to raise his charity needs, then at operation 220, the charity requestor 165 is able to search for unmatched charity supplies within the community group 125. At operation 222, the system displays the results of the unmatched charity supplies within the community group 125 as part of the search, along with the option to view messages related to them.

At operation 225, the charity requestor 165 decides if the unmatched charity supplies within the community group 125, satisfies part or all of his charity needs for goods and services or not. If the unmatched charity supplies within the community group 125, satisfies part or all of the charity requestor 165 charity needs for goods and services, then at operation 230 the charity requestor 165 is able to raise his charity needs for goods and services against the unmatched charity supplies which satisfies part of all of his charity needs (i.e., the charity requestor 165 claims the part or all of the unmatched charity supplies for himself and specify the amount of charity supplies he needs, which may be more than the unmatched charity supplies available). Also at operation 230, the charity requestor 165 is able to specify the estimated value in terms of estimated CommunityValue for each of his need for goods and services.

At operation 235 the system marks the portion of the charity needs for goods and services of the charity requestor 165 that will be supplied based on his claim, by the unmatched charity supplies within the community group 125, as “Matched”. The system also marks the unmatched charity supplies which will be used to satisfy the charity requestor 165 needs for goods and services based on his claim as “Matched”. The system also stores information regarding matched charity needs and the matched charity supplies, along with information on who has the needs and who will be supplying for the needs. The system also stores the excess portion of the charity needs for goods and services (if any) of the charity requestor 165, that will not be supplied in the current transaction by the unmatched charity supplies within the community group 125, with status “Unmatched”.

If at operation 225, the charity requestor 165 decides that the unmatched charity supplies within the community group 125 displayed at operation 222, does not satisfy part or all of his charity needs for goods and services, then at operation 240 the charity requestor 165 is able to raise his charity needs for goods and services in the community group 125. Also at operation 240, the charity requestor 165 is able to specify the estimated value in terms of estimated CommunityValue for each of his charity need for goods and services.

At operation 245 the system stores the charity needs for goods and services of the charity requestor 165, within the community group 125, with status “Unmatched”.

If at operation 215, the charity requestor 165 decides that he does not want to raise his charity needs, then at operation 250, the charity requestor 165 decides if he wants to view his unmatched charity needs or not. If the charity requestor 165 decides he wants to view his unmatched charity needs, then at operation 255 the unmatched charity needs of the charity requestor 165 are displayed to him by the system, along with the option to view messages related to them. At operation 260 the charity requestor 165 is able to make changes to his unmatched charity needs if he wills to do so.

If at operation 250, charity requestor 165 decides he does not want to view his unmatched charity needs, then at operation 265 the charity needs of the charity requestor 165 that do not have the status “Unmatched” are displayed to him by the system, along with the option to view messages related to them. These include but are not limited to the charity needs of the charity requestor 165 with status “Matched” and “Confirmed”.

At operation 270 the charity requestor 165 decides if he wants to confirm any of his charity needs displayed in operation 265, which have a status of “Matched” as being met by the respective charity supplier 170 involved in the match or not. If the charity requestor 165 decides that he wants to confirm his matched charity needs as being met because he has received the corresponding charity supplies, then he does so at operation 275. Also, at operation 275 the charity requestor 165 has the option to specify the actual value in terms of actual CommunityValue for the charity needs that were met. In some embodiments not all the actual CommunityValue is defaulted to the estimated CommunityValue in the matched charity needs.

At operation 280 the actual CommunityValue specified for the charity needs that were confirmed as met, is used to create CommunityValue of the community group 125 (community group being the group where the charity need was raised), with amount set as the actual CommunityValue specified, and this newly created CommunityValue is then assigned to the respective charity supplier 170 by the system, which results in the charity supplier's 170 CommunityValue balance of the community group 125 increasing by the amount of the newly created CommunityValue.

Also, at operation 280 in some embodiments not all, a percentage of actual CommunityValue specified is computed and is used to create CommunityValue of the community group 125 (community group being the group where the charity need was raised), with amount set as the computed value, and this newly created CommunityValue is then assigned to the community enabler 187 by the system, which results in the community enabler's 187 CommunityValue balance of the community group 125 increasing by the amount of the newly created CommunityValue.

Also, at operation 280 the charity needs that were confirmed as met are marked as “Confirmed” (i.e., status is set to “Confirmed”). Also, at operation 280 the charity supplies, that were used to meet the charity needs that were confirmed as met, are marked as “Confirmed” (i.e., status is set to “Confirmed”).

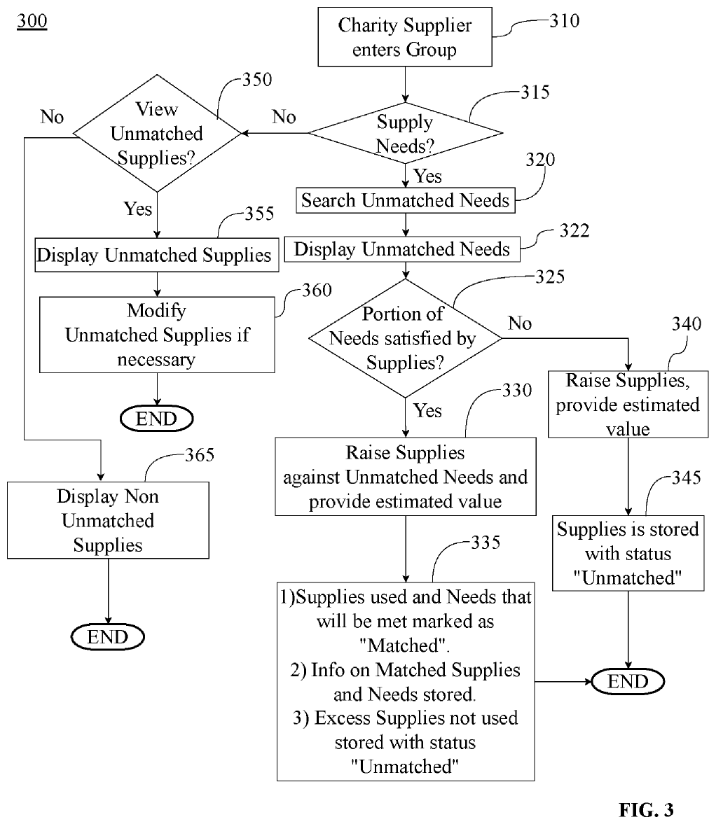

FIG. 3 shows a flow diagram of an exemplary embodiment 300 of the present invention which shows some of the, not all the, operations performed by the system and a charity supplier 170.

At operation 310, a charity supplier 170 enters a community group 125 in which he is a community group member 160.

At operation 315, the charity supplier 170 decides if he wants to supply charity needs for goods and services within the community group 125 or not. If the charity supplier 170 wants to supply charity needs using his charity supplies, then at operation 320, the charity supplier 170 is able to search for unmatched charity needs within the community group 125. At operation 322, the system displays the results of the unmatched charity needs within the community group 125 as part of the search, along with the option to view messages related to them.

At operation 325, the charity supplier 170 decides if the unmatched charity needs within the community group 125, can be satisfied in part or in all by his charity supplies of goods and services. If the unmatched charity needs within the community group 125, is satisfied in part or in all by the charity supplier 170 charity supplies, then at operation 330 the charity supplier 170 is able to raise his charity supplies against the unmatched charity needs which are satisfied in part or in all by his charity supplies of goods and services (i.e., the charity supplier 170 is able to take responsibility to provide for part or all of the unmatched charity needs and specify the amount of charity needs he can supply, which may be more than the unmatched charity needs which is present). Also at operation 330, the charity supplier 170 is also able to specify the estimated value in terms of estimated CommunityValue for each of his charity supply of goods and services.

At operation 335 the system marks the portion of the charity supplies of goods and services of the charity supplier 170 that will be used to supply unmatched charity needs within the community group 125 as “Matched”. The system also marks the unmatched charity needs for goods and services which will be satisfied by the charity supplier 170 as “Matched”. The system also stores information regarding matched charity needs and the matched charity supplies, along with information on who has the needs and who will be supplying for the needs. The system also stores the excess portion of the charity supplies of goods and services (if any) of the charity supplier 170, that will not be used to supply the unmatched charity needs in the current transaction, within the community group 125 with status “Unmatched”.

If at operation 325, the charity supplier 170 decides that the unmatched charity needs within the community group 125 displayed at operation 322, cannot be satisfied by in part or in all by his charity supplies of goods and services, then at operation 340 the charity supplier 170 is able to raise his charity supplies of goods and services in the community group 125. Also at operation 340, the charity supplier 170 is able to specify the estimated value in terms of estimated CommunityValue for each of his charity supply of goods and services.

At operation 345 the system stores the charity supplies of goods and services of the charity requestor 165, within the community group 125, with status “Unmatched”.

If at operation 315, the charity supplier 170 decides that he does not want to supply charity needs, then at operation 350, the charity supplier 170 decides if he wants to view his unmatched charity supplies or not. If the charity supplier 170 decides he wants to view his unmatched charity supplies, then at operation 355 the unmatched charity supplies of the charity supplier 170 are displayed to him by the system, along with the option to view messages related to them. At operation 360 the charity supplier 170 is able to make changes to his unmatched charity supplies if he wills to do so.

If at operation 350, charity requestor 165 decides he does not want to view his unmatched charity supplies, then at operation 365 the charity supplies of the charity supplier 170 that do not have the status “Unmatched” are displayed to him by the system, along with the option to view messages related to them. These include but are not limited to the charity supplies of the charity requestor 165 with status “Matched” and “Confirmed”

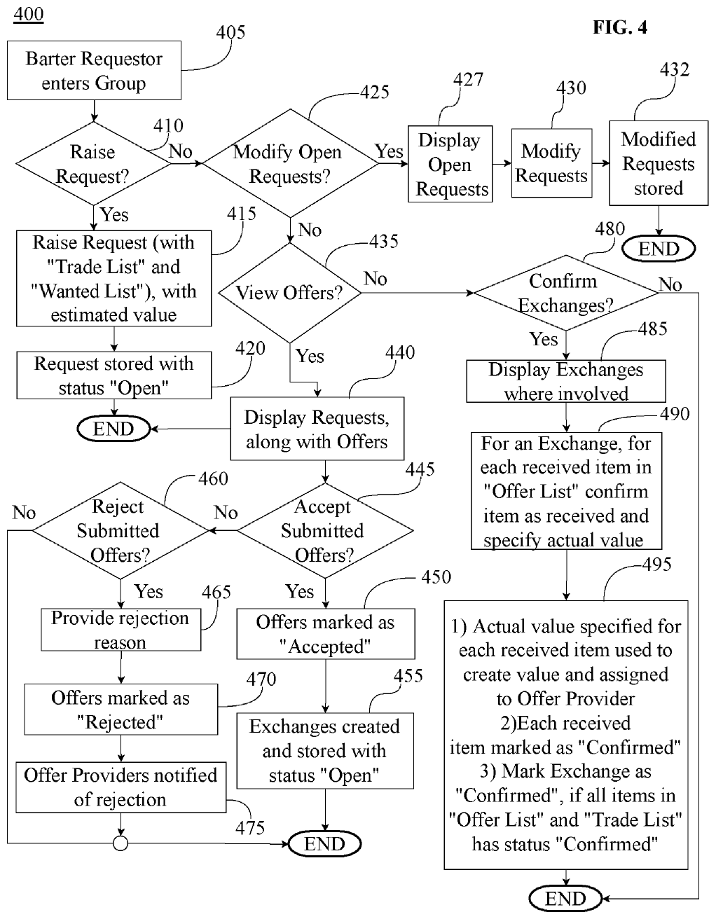

FIG. 4 shows a flow diagram of an exemplary embodiment 400 of the present invention which shows some of the, not all the, operations performed by the system and a barter requestor 175.

At operation 405, a barter requestor 175 enters a community group 125 in which he is a community group member 160.

At operation 410, the barter requestor 175 decides if he wants to raise a barter request within the community group 125 or not. If at operation 410 the barter requestor 175 decides that he wants to raise a barter request, then he can do so at operation 415.

At operation 415 the barter requestor 175 raises a barter request within the community group 125, in which he provides a “Trade List” which contains the list of items of goods and services that he is willing to provide in return for a “Wanted List” which contains the list of items of goods and services that he requires. Also at operation 415, the barter requestor 175 is also able to specify the estimated value in terms of estimated CommunityValue for each item of goods and services in the “Trade List” and the “Wanted List” present in the barter request. In some embodiments not all the barter requestor 175 is permitted to leave the “Wanted List” empty, indicating that the barter requestor 175 is ready to consider any barter offer for the items he will be providing in the barter request. In some embodiments not all, the barter requestor 175 is permitted to indicate that he is willing to receive barter offers outside the “Wanted List”, and that the “Wanted List” is just a list of items he prefers to get in return as part of a barter offer, for the items he will be providing in the barter request. In some embodiments not all, the barter requestor 175 is allowed to indicate that he requires all the items in the “Wanted List” to be present in the “Offer List” of barter offers for his barter request.

At operation 420 the barter request is stored within the community group 125 with status “Open”.

If at operation 410 the barter requestor 175 decides that he does not want to raise a barter request, then at operation 425 the barter requestor 175 decides if he wants to modify his barter requests with status “Open” or not. If at operation 425 the barter requestor 175 decides that he wants to modify his barter requests with status “Open”, then at operation 427 the system displays his open barter requests, along with the option to view messages related to them.

At operation 430 the barter requestor 175 selects the open barter requests that he wants to modify and modifies them. At operation 432, each of the modified barter request is stored within the Group with status “Open”. In some embodiments not all if any submitted barter offers were impacted on account to the modifications to the barter request, these are marked as “Rejected” (i.e., status is set to “Rejected”), with the rejection reason indicating the rejection on account of changes to the open barter request, and the impacted barter offer providers 180 are informed of the rejection.

If at operation 425 the barter requestor 175 decides that he does not want to modify his barter request with status “Open”, then at operation 435 the barter requestor 175 decides if he wants to view offers received for his barter requests or not.

If at operation 435 the barter requestor 175 decides that he wants to view offers received for his barter requests, then at operation 440, the system displays the barter requests of the barter requestor 175, along with the option to view messages related to them. Also at operation 440, the system also displays the barter offers received for each of his barter requests, along with the option to view messages related to the barter offers.

At operation 445 the barter requestor 175 decides if he wants to accept the batter offers with status “Submitted”, offered against his open barter requests or not.

If at operation 445 the barter requestor 175 decides that he wants to accept selected batter offers with status “Submitted”, offered against his open barter requests, then at operation 450, the barter offers selected for acceptance by the barter requestor 175 are marked as “Accepted” (i.e., status is set to “Accepted”).

At operation 455, a barter exchange is created and stored within the community group 125 with status “Open” by the system, for each of the accepted batter offers which were made against corresponding barter requests. This barter exchange data includes but is not limited to “Offer List” from the accepted barter offer, the “Trade List” from the corresponding barter request, information on the barter requestor 175 who would be providing the items in the “Trade List” and information on the barter offer provider 180 who would be providing the items in the “Offer List”. This barter exchange represents a commitment made by the barter offer provider 180 to provide items in “Offer List” of the barter offer, in exchange for the commitment made by the barter requestor 175 to provide items in the “Trade List” of the corresponding barter request and vice versa.

If at operation 445 the barter requestor 175 decides that he does not want to accept selected batter offers with status “Submitted”, offered against his open barter requests. Then at operation 460, the barter requestor 175 decides if he wants to reject selected batter offers with status “Submitted”, offered against his open barter requests or not. If at operation 460, the barter requestor 175 decides that he wants to reject selected batter offers, then at operation 465 the barter requestor 175 provides the reason for rejection of the selected barter offers.

At operation 470, the selected barter offers are marked as “Rejected” (i.e., status is set to “Rejected”) by the system. At operation 475, the corresponding barter offer providers 180 of the rejected barter offers are notified of the rejections by the system, along with the rejection reason.

If at operation 435 the barter requestor 175 decides that he does not want to view offers received for his barter requests, then at operation 480, the barter requestor 175 decides if he wants to confirm receipt of items in an “Offer List” that is part of a barter exchange where he is involved as a barter requestor 175 or not.

If at operation 480 the barter requestor 175 decides that he wants to confirm receipt of items in an “Offer List” that is part of a barter exchange where he is involved as a barter requestor 175, then at operation 485 the system displays barter exchanges where the barter requestor 175 is involved as a barter requestor 175, along with the option to view messages related to them.

At operation 490 the barter requestor 175 confirms items of goods and services in the “Offer List” that have been received by him, as part of a barter exchange. Also, at operation 490 the barter requestor 175 has the option to specify the actual value in terms of actual CommunityValue for each item in the “Offer List” that has been received. In some embodiments not all the actual CommunityValue for each item on the “Offer List” that has been received, is defaulted to the estimated CommunityValue for each item on the “Offer List” that has been received.

At operation 495 the actual CommunityValue specified for each item in the “Offer List” that has been received, as part of the barter exchange, is used to create CommunityValue of the community group 125 (community group being the group where the barter request was raised) with amount set as the actual CommunityValue specified, and this newly created CommunityValue is then assigned to the respective barter offer provider 180 who provided the item in the “Offer List” by the system, which results in the barter offer provider's 180 CommunityValue balance of the community group 125 increasing by value of the newly created Community Value.

Also, at operation 495 in some embodiments not all, a percentage of actual CommunityValue specified for each item in the “Offer List” is computed and is used to create CommunityValue of the community group 125 (community group being the group where the barter request was raised), with amount set as the computed value, and this newly created CommunityValue is then assigned to the community enabler 187 by the system, which results in the community enabler's 187 CommunityValue balance of the community group 125 increasing by value of the newly created Community Value.

Also, at operation 495 each item on the “Offer List” that has been received, as part of the barter exchange, is marked as “Confirmed” (i.e., status is set to “Confirmed”). Also at operation 495, if all the items in the “Offer List” have status “Confirmed” (i.e., “Confirmed” as has been received by the barter requestor 175), and if all items in the “Trade List” have status “Confirmed” (i.e., “Confirmed” as has been received by the barter offer provider 180), the status of the barter exchange is marked as “Confirmed” by the system.

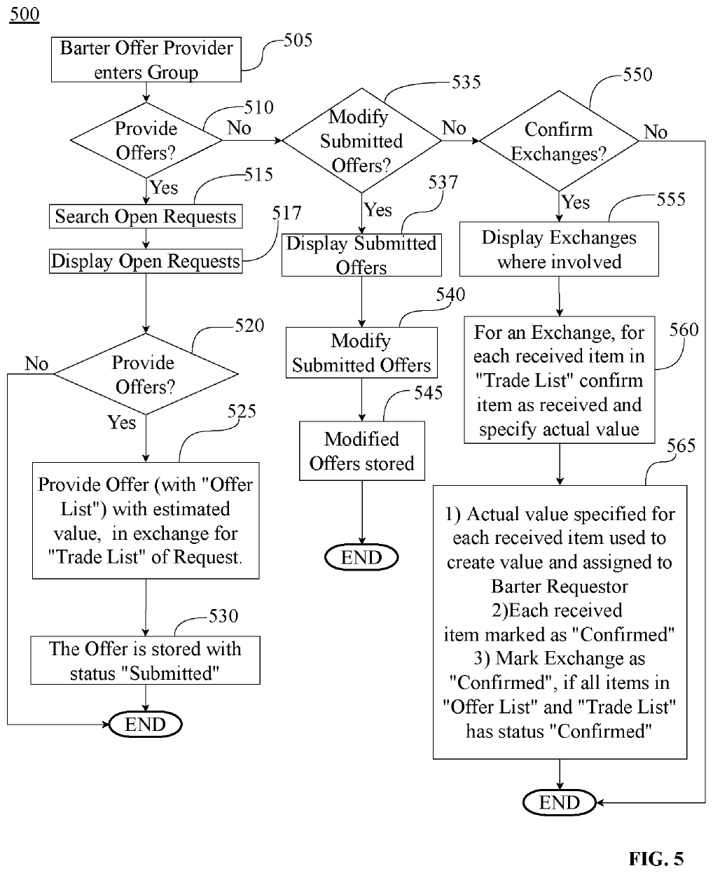

FIG. 5 shows a flow diagram of an exemplary embodiment 500 of the present invention which shows some of the, not all the, operations performed by the system and a barter offer provider 180.

At operation 505, a barter offer provider 180 enters a community group 125 in which he is a community group member 160.

At operation 510, the barter offer provider 180 decides if he wants to provide barter offers against existing open barter requests within the community group 125 or not. If at operation 510 the barter offer provider 180 decides that he wants to provide barter offers against existing open barter requests, then he can search for open barter requests within the community group 125 at operation 515. At operation 517, the system displays the results of the search for open barter requests within the community group 125, along with “Trade List” and the “Wanted List” of each of the open barter requests. Also at the operation 517, the system provides the option to view messages related to each of the open barter requests that are displayed.

At operation 520, the barter offer provider 180 decides if he wants to provide barter offers against the displayed open barter requests within the community group 125 or not. If the barter offer provider 180 decides that he wants to provide barter offers against the displayed open barter requests within the community group 125, then he is able to do so at operation 525.

At operation 525, the barter offer provider 180 selects the displayed open barter requests for which he wants to provide a barter offer, and for each of the selected open barter requests the barter offer provider 180 is able to provide a barter offer with an “Offer List” containing items of goods and services that he is willing to provide in exchange for the items in the “Trade List” of the corresponding open barter request. Also in operation 525, the barter offer provider 180 provides the estimated value in terms of estimated CommunityValue for each item on the “Offer List” in the barter offers. In some embodiments not all, the barter offer provider 180 is permitted to provide a barter offer with an “Offer List” different from the “Wanted List” of the open barter request provided that the barter request permits it.

At operation 530 the barter offers are stored within the Group with status “Submitted” by the system.

If at operation 510 the barter offer provider 180 decides that he does not want to provide barter offers against existing open barter requests, then at operation 535 the barter offer provider 180 decides if he wants to modify his barter offers with status “Submitted” or not. If at operation 535 the barter offer provider 180 decides that he wants to modify his barter offers with status “Submitted”, then at operation 537 the system displays his submitted barter offers, along with the option to view messages related to them.

At operation 540 the barter offer provider 180 selects the submitted barter offers he wants to modify and modifies them. At operation 545, each of the modified barter offer, against barter requests, is stored within the Group with status “Submitted” by the system. The checks pertaining to the barter offer, including but not limited by the “Offer List” of the barter offer contains items in the “Wanted List” of the barter request depending on the type of barter request, continues to remain in place during barter offer modification.

If at operation 535 the barter offer provider 180 decides he does not want to modify his barter offers with status “Submitted”, then at operation 550 the barter offer provider 180 decides if he wants to confirm receipt of items in a “Trade List” that is part of a barter exchange where he is involved as a barter offer provider 180 or not.

If at operation 550 the barter offer provider 180 decides that he wants to confirm receipt of items in a “Trade List” that is part of a barter exchange where he is involved as a barter offer provider 180, then at operation 555 the system displays barter exchanges where the barter offer provider 180 is involved as a barter offer provider 180, along with the option to view messages related to them.

At operation 560 the barter offer provider 180 confirms items of goods and services in the “Trade List” that have been received by him, as part of a barter exchange. Also, at operation 560 the barter offer provider 180 has the option to specify the actual value in terms of actual CommunityValue for each item in the “Trade List” that has been received. In some embodiments not all the actual CommunityValue, for each item on the “Trade List” that has been received, is defaulted to the estimated CommunityValue for each item on the “Trade List” that has been received.

At operation 565 the actual CommunityValue specified for each item in the “Trade List” that has been received, as part of the barter exchange, is used to create CommunityValue of the community group 125 with amount set as the actual CommunityValue specified, and this newly created CommunityValue is then assigned to the respective barter requestor 175 who provided the item in the “Trade List” by the system, which results in the barter requestor's 175 CommunityValue balance of the community group 125 increasing by value of the newly created CommunityValue.

Also, at operation 565 in some embodiments not all, a percentage of actual CommunityValue specified for each item in the “Trade List” is computed and is used to create CommunityValue of the community group 125 (community group being the group where the barter request was raised), with amount set as the computed value, and this newly created CommunityValue is then assigned to the community enabler 187 by the system, which results in the community enabler's 187 CommunityValue balance of the community group 125 increasing by value of the newly created Community Value.

Also, at operation 565 each item on the “Trade List” that has been received, as part of the barter exchange, is marked as “Confirmed” (i.e., status is set to “Confirmed”). Also at operation 495, if all the items in the “Offer List” have status “Confirmed” (i.e., “Confirmed” as has been received by the barter requestor 175), and if all items in the “Trade List” have status “Confirmed” (i.e., “Confirmed” as has been received by the barter offer provider 180), the status of the barter exchange is marked as “Confirmed” by the system.

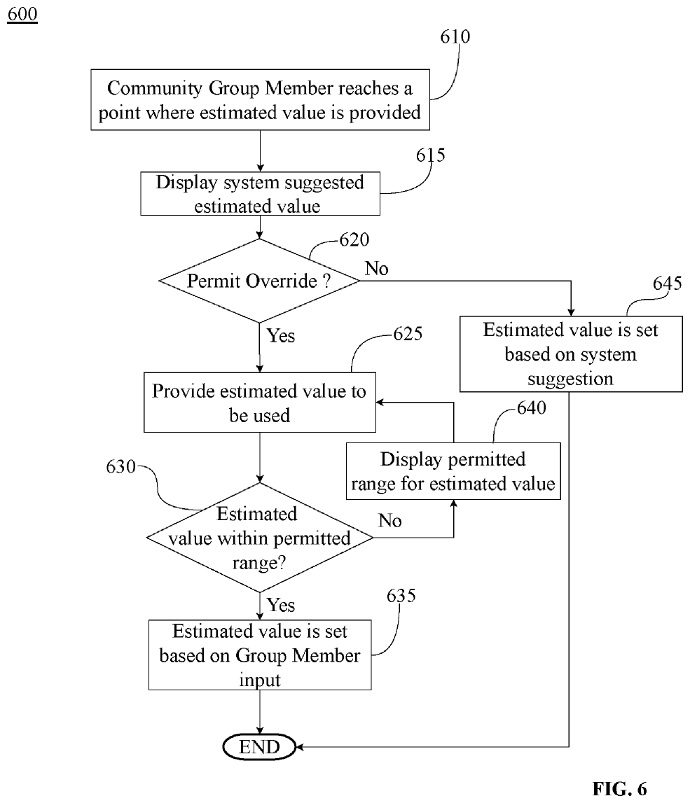

FIG. 6 shows a flow diagram of an exemplary embodiment 600 of the present invention which shows a possible implementation, not all, of the way estimated value expressed in terms of estimated CommunityValue could be set for goods and services.

At operation 610, a community group member 160 of a specific community group 125 reaches a point in the various processes of an embodiment of the present invention, where the estimated value expressed in terms of estimated CommunityValue for goods and services is provided such as, but not limited to, operation 230, operation 240, operation 330, operation 340, operation 415, operation 525.

At operation 615, the system displays the system suggested estimated CommunityValue for goods and services in concern. The systems suggested estimated CommunityValue can be determined by various means including but not limited to, determined by trained Artificial Intelligence/Machine Learning Models which were trained using actual data of estimated CommunityValue set by community group members 160 of the specific community group 125 for goods and services in concern or were trained using actual data of estimated CommunityValue set by users 120 for the goods and services in concern for goods and services in concern, determined by community group 125 configurations set by the community group admin 150 for goods and services in concern, determined by configurations set by the system admin 185 for goods and services in concern.

At operation 620, the system checks to see if the system is configured to allow community group member 160 to override the system suggested estimated CommunityValue for the goods and services in concern or not. If at operation 620 it is determined that the community group member 160 is permitted to override the system suggested estimated CommunityValue for the goods and services in concern, then at operation 625 the community group member 160 provides estimated CommunityValue to be used (which could be same as the system suggested estimated CommunityValue) for the goods and services in concern.

At operation 630, the system first determines the permitted range within which the estimated CommunityValue for the goods and services in concern should fall, for determining the permitted range various means can be used by the system including but not limited to, determining the permitted range by using trained Artificial Intelligence/Machine Learning Models which were trained using actual data of estimated CommunityValue set by community group members 160 of the specific community group 125 for the goods and services in concern or were trained using actual data of estimated CommunityValue set by users 120 for the goods and services in concern, determining the permitted range by configurations set by the community group admin 150 for the goods and services in concern, determining the permitted range by configurations set by the system admin 185 for the goods and services in concern.

Also at operation 630, the system checks to see if the estimated CommunityValue provided by the community group member 160 at operation 625 is within the permitted range determined by the system for the goods and services in concern or not. If at the operation 630 it is determined that the estimated CommunityValue provided by the community group member 160 at operation 625 is within the permitted range determined by the system for the goods and services in concern, then at operation 635 the estimated CommunityValue for the goods and services is set based on community group member's 160 input for the goods and services in concern.

If at the operation 630 it is determined that the estimated CommunityValue provided by the community group member 160 at operation 625 is not within the permitted range determined by the system for the goods and services in concern, then at operation 640 system displays the permitted range within which the estimated CommunityValue for the goods and services in concern should fall for the system to accept the estimated CommunityValue provided by the community group member 160 for the goods and services in concern.

If at operation 620 it is determined that the community group member 160 is not permitted to override the system suggested estimated CommunityValue for the goods and services in concern, then at operation 645 the estimated CommunityValue for the goods and services in concern is set based on system suggested estimated CommunityValue for the goods and services in concern.

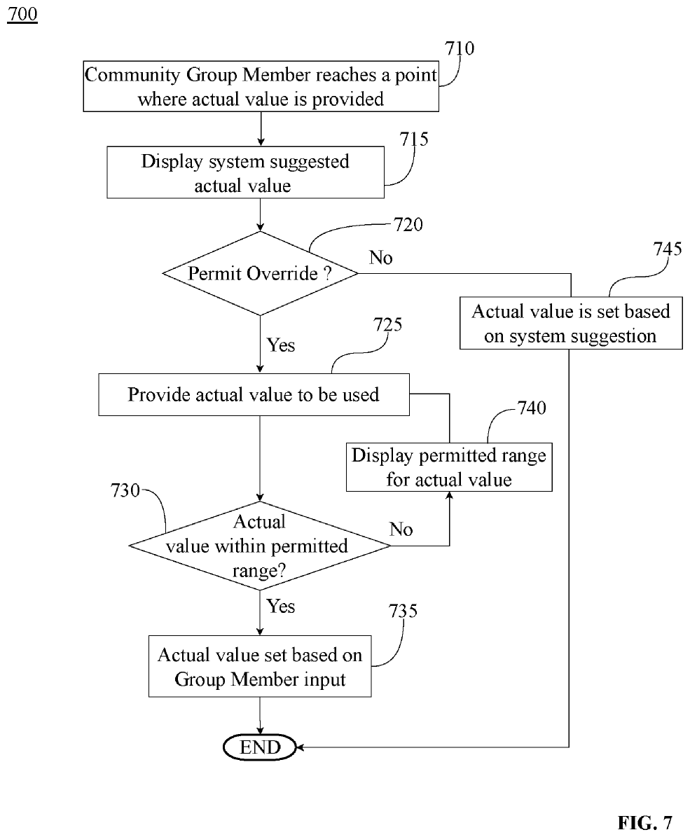

FIG. 7 shows a flow diagram of an exemplary embodiment 700 of the present invention which shows a possible implementation, not all, of the way actual value expressed in terms of actual CommunityValue could be set for goods and services.

At operation 710, a community group member 160 reaches a point in the various processes of an embodiment of the present invention, where the actual value expressed in terms of actual CommunityValue for goods and services is provided such as, but not limited to, operation 275, operation 490, operation 560, operation 2135, operation 2245.

At operation 715, the system displays the system suggested actual CommunityValue for goods and services in concern. The systems suggested actual CommunityValue can be determined by various means including but not limited to, determined by trained Artificial Intelligence/Machine Learning Models which were trained using actual data of actual CommunityValue set by community group members 160 of the specific community group 125 for goods and services in concern or were trained using actual data of actual CommunityValue set by users 120 for goods and services in concern, determined by community group 125 configurations set by the community group admin 150 for goods and services in concern, determined by configurations set by the system admin 185 for goods and services in concern.

At operation 720, the system checks to see if the system is configured to allow community group member 160 to override the system suggested actual CommunityValue for the goods and services in concern or not. If at operation 720 it is determined that the community group member 160 is permitted to override the system suggested actual CommunityValue for the goods and services in concern, then at operation 725 the community group member 160 provides actual CommunityValue to be used (which could be same as the system suggested actual Community Value) for the goods and services in concern.

At operation 730, the system first determines the permitted range within which the actual CommunityValue for the goods and services in concern should fall, for determining the permitted range various means can be used by the system including but not limited to, determining the permitted range by using trained Artificial Intelligence/Machine Learning Models which were trained using actual data of actual CommunityValue set by community group members 160 of the specific community group 125 for the goods and services in concern or were trained using actual data of actual CommunityValue set by users 120 for the goods and services in concern, determining the permitted range by configurations set by the community group admin 150 for the goods and services in concern, determining the permitted range by configurations set by the system admin 185 for the goods and services in concern.

Also at operation 730, the system checks to see if the actual CommunityValue provided by the community group member 160 at operation 725 is within the permitted range determined by the system for the goods and services in concern or not. If at the operation 730 it is determined that the actual CommunityValue provided by the community group member 160 at operation 725 is within the permitted range determined by the system for the goods and services in concern, then at operation 735 the actual CommunityValue for the goods and services is set based on community group member's 160 input for the goods and services in concern.

If at the operation 730 it is determined that the actual CommunityValue provided by the community group member 160 at operation 725 is not within the permitted range determined by the system for the goods and services in concern, then at operation 740 system displays the permitted range within which the actual CommunityValue for the goods and services in concern should fall for the system to accept the actual CommunityValue provided by the community group member 160 for the goods and services in concern.

If at operation 720 it is determined that the community group member 160 is not permitted to override the system suggested actual CommunityValue for the goods and services in concern, then at operation 745 the actual CommunityValue for the goods and services in concern is set based on system suggested actual CommunityValue for the goods and services in concern.

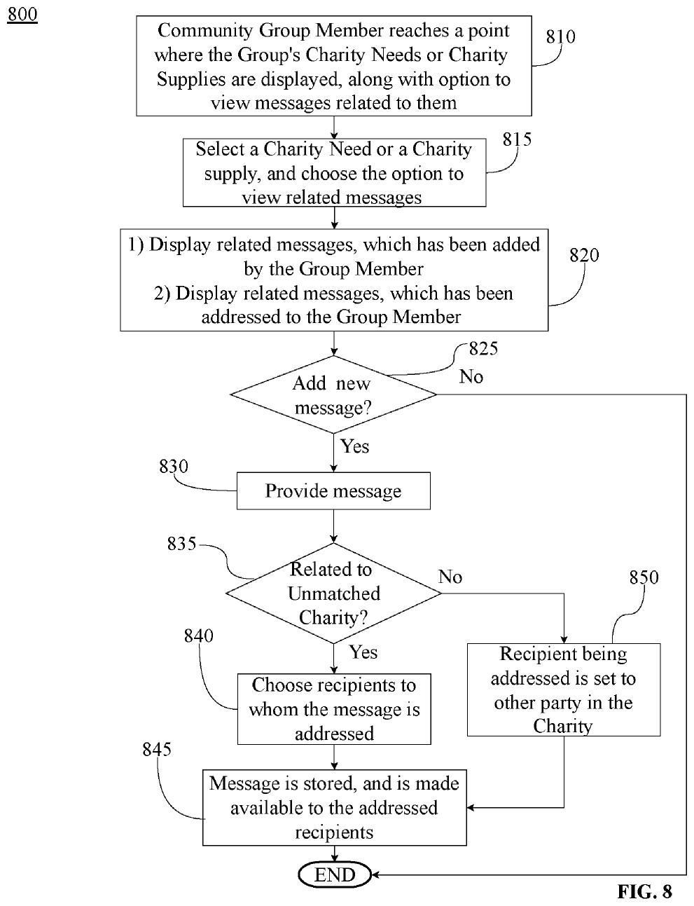

FIG. 8 shows a flow diagram of an exemplary embodiment 800 of the present invention which shows a possible implementation, not all, of the way messages may be exchanged between community group members 160, for charity needs or for charity supplies.

At operation 810, a community group member 160 reaches a point in the various processes of an embodiment of the present invention, where the community group member 160 is able to view option to view the messages related to either the charity needs or charity supplies such as, but not limited to, operation 222, operation 255, operation 265, operation 322, operation 355, operation 365.

At operation 815 the community group member 160 chooses either a charity need or a charity supply and chooses the option to view messages related to it.

At operation 820, the system displays messages related to either the chosen charity need or the chosen charity supply, which has been added by the community group member 160. Also, at operation 820 the system displays messages related to either the chosen charity need or the chosen charity supply, which has been addressed to the community group member 160.

At operation 825, the community group member 160 decides if he wants to add a new message with respect to the chosen charity need or the chosen charity supply or not. If at operation 825 the community group member 160 decides that he wants to add a new message with respect to the chosen charity need or the chosen charity supply, then at operation 830 the community group member 160 provides the message to be added against the chosen charity need or the chosen charity supply.

At operation 835, the system checks to see if the message that is being added is related to either to an unmatched charity need or an unmatched charity supply or not. If at operation 835 it is determined that the message that is being added is related either an unmatched charity need or an unmatched charity supply, then at operation 840 the community group member 160 is able to choose other community group members 160 as the recipients to whom the added message is addressed. If at operation 840 the community group member 160 does not specify recipients to whom the added message is addressed, then the system defaults the recipients to whom the added message is addressed as all community group members 160 of the community group 125.

At operation 845, the message is stored, and is made available to the addressed recipients by the system.

If at operation 835 it is determined that the message that is being added is NOT related to either an unmatched charity need or an unmatched charity supply, then at operation 850 the recipient to whom the added message is addressed is set as the other party involved in the post matched charity need or matched charity supply (i.e., the other party is set as the other community group member 160 other than the current community group member 160, involved in the chosen charity need or the chosen charity supply at the time when the chosen charity need or the chosen charity supply was marked as “Matched”)

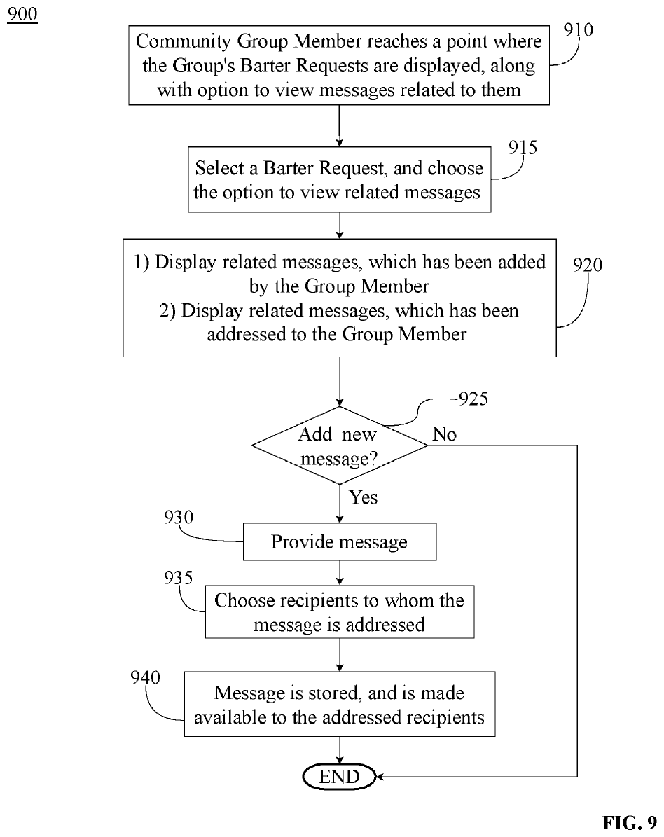

FIG. 9 shows a flow diagram of an exemplary embodiment 900 of the present invention which shows a possible implementation, not all, of the way messages may be exchanged between community group members 160, for barter requests.

At operation 910, a community group member 160 reaches a point in the various processes of an embodiment of the present invention, where the community group member 160 is able to view option to view the messages related to barter requests such as, but not limited to, operation 427, operation 440, operation 517.

At operation 915 the community group member 160 chooses a barter request and chooses the option to view messages related to it.

At operation 920, the system displays messages related to the chosen barter request, which has been added by the community group member 160. Also, at operation 920 the system displays messages related to the chosen barter request, which has been addressed to the community group member 160.

At operation 925, the community group member 160 decides if he wants to add a new message with respect to the chosen barter request or not. If at operation 925 the community group member 160 decides that he wants to add a new message with respect to the chosen barter request, then at operation 930 the community group member 160 provides the message to be added against the chosen barter request.

At operation 935, the community group member 160 is able to choose other community group members 160 as the recipients to whom the added message is addressed. If at operation 935 the community group member 160 does not specify recipients to whom the added message is addressed, then the system defaults the recipients to whom the added message is addressed as all community group members 160 of the community group 125.

At operation 940, the message is stored, and is made available to the addressed recipients by the system.

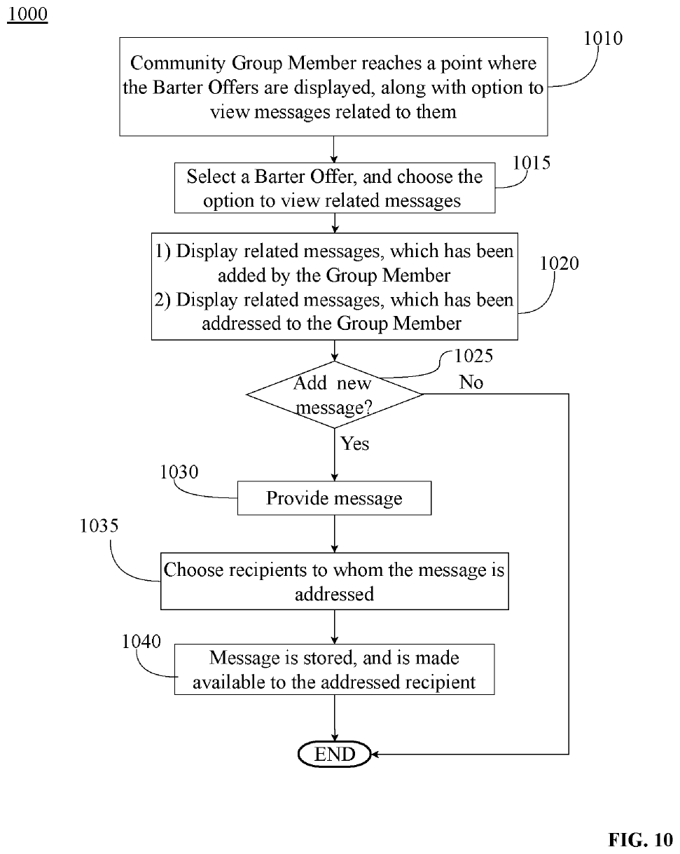

FIG. 10 shows a flow diagram of an exemplary embodiment 1000 of the present invention which shows a possible implementation, not all, of the way messages may be exchanged between community group members 160, for barter offers.

At operation 1010, a community group member 160 reaches a point in the various processes of an embodiment of the present invention, where the community group member 160 is able to view option to view the messages related to the batter offers received for his barter request or where the community group member 160 is able to view option to view the messages related his batter offers such as, but not limited to, operation 440, operation 537.

At operation 1015 the community group member 160 chooses a barter offer and chooses the option to view messages related to it.

At operation 1020, the system displays messages related to the chosen barter offer, which has been added by the community group member 160. Also, at operation 1020 the system displays messages related to the chosen barter offer, which has been addressed to the community group member 160.

At operation 1025, the community group member 160 decides if he wants to add a new message with respect to the chosen barter offer or not. If at operation 1025 the community group member 160 decides that he wants to add a new message with respect to the chosen barter offer, then at operation 1030 the community group member 160 provides the message to be added against the chosen barter offer.

At operation 1035, the community group member 160 is able to choose other community group members 160 as the recipients to whom the added message is addressed. If at operation 1035 the community group member 160 does not specify recipients to whom the added message is addressed, then the system defaults the recipients to whom the added message is addressed as all community group members 160 of the community group 125.

At operation 1040, the message is stored, and is made available to the addressed recipients by the system.

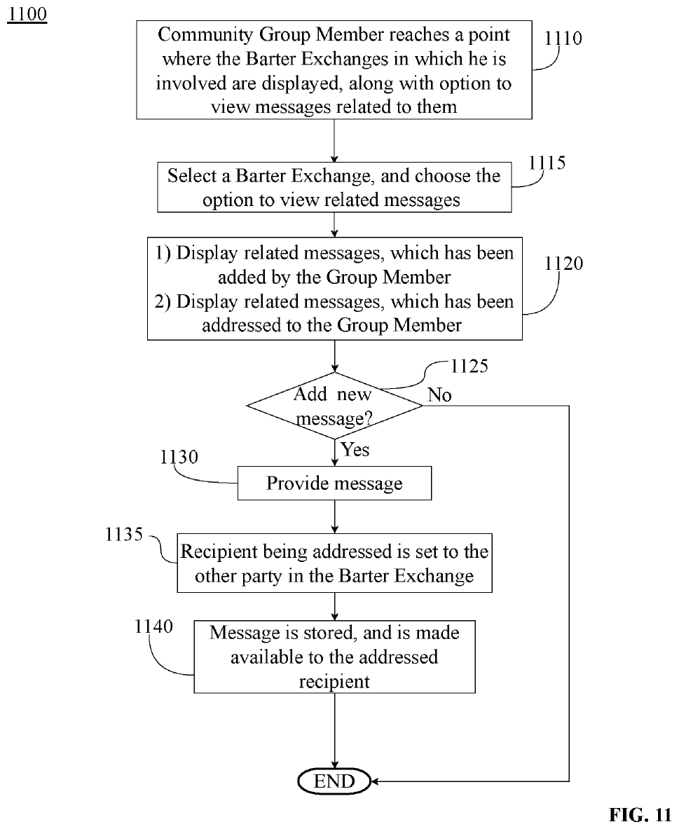

FIG. 11 shows a flow diagram of an exemplary embodiment 1100 of the present invention which shows a possible implementation, not all, of the way messages may be exchanged between community group members 160, for barter exchanges in which the community group members 160 are involved.

At operation 1110, a community group member 160 reaches a point in the various processes of an embodiment of the present invention, where the community group member 160 is able to view option to view the messages related to barter exchanges in which the community group member 160 is involved such as, but not limited to, operation 485, operation 555.

At operation 1115 the community group member 160 chooses a barter exchange in which he is involved and chooses the option to view messages related to it.

At operation 1120, the system displays messages related to the chosen barter exchange, which has been added by the community group member 160. Also, at operation 1120 the system displays messages related to the chosen barter exchange, which has been addressed to the community group member 160.

At operation 1125, the community group member 160 decides if he wants to add a new message with respect to the chosen barter exchange or not. If at operation 1125 the community group member 160 decides that he wants to add a new message with respect to the chosen barter exchange, then at operation 1130 the community group member 160 provides the message to be added against the chosen barter exchange.

At operation 1135, the recipient being addressed is set to the other party (i.e., the community group member 160 other than the current community group member 160 involved in the barter exchange) involved in the barter exchange

At operation 1140, the message is stored, and is made available to the addressed recipient by the system.

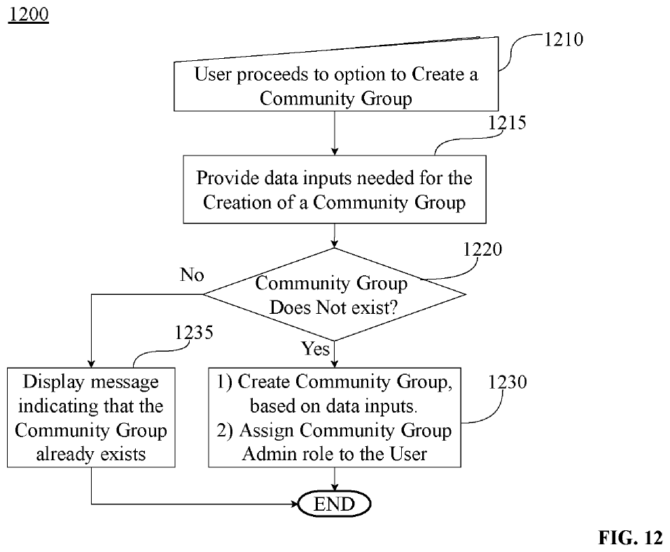

FIG. 12 shows a flow diagram of an exemplary embodiment 1200 of the present invention which shows a possible implementation, not all, of the way in a which a user 120 can create a community group 125.

At operation 1210, the user 120 proceeds to the option to create a community group 125.

At operation 1215 the user 120 provide data inputs needed for the creation of a community group 125.

At operation 1220, based on the data inputs provided by the user 120 for the creation of a community group 125, the system checks to see if the community group 125 does not already exist in the system, or it does already exist in the system. If at operation 1220, based on the data inputs provided by the user 120 for the creation of a community group 125, the system determines that the community group 125 does not already exist in the system, then at operation 1230 the community group 125 is created based on the data inputs of the user 120. Also, at operation 1230 the user 120 is assigned the role of the community group admin 150 for the newly created community group 125.

If at operation 1220, based on the data inputs provided by the user 120 for the creation of a community group 125, the system determines that the community group 125 does already exists in the system, then at operation 1235 the display message to the user 120 indicating that the community group 125 already exists.

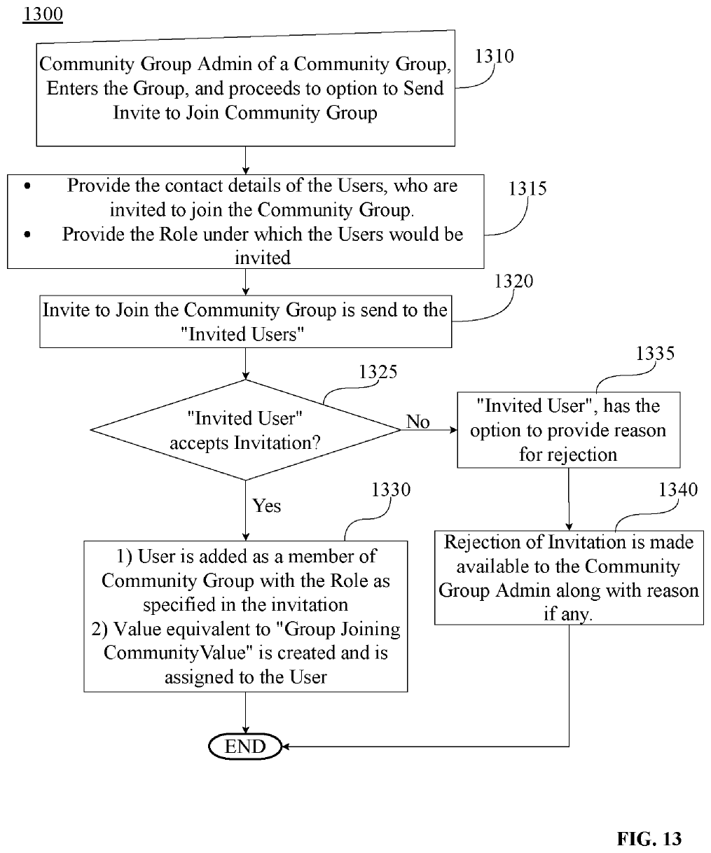

FIG. 13 shows a flow diagram of an exemplary embodiment 1300 of the present invention which shows a possible implementation, not all, of the way in a which a community group admin 150 of a community group 125 is able to invite users 120 to join the community group 125.

At operation 1310, the community group admin 150 of a community group 125 enters the community group 125, and proceeds to the option to send invite to join community group.

At operation 1315, the community group admin 150 provide the contact details of the users 120, who are to be invited to join the community group 125. Also, at operation 1315 the community group admin 150 provide the roles that will be assigned to the invited users 120 if they accept the invitation to join the community group 125 and selects the option to invite users to join community group.

At operation 1320, the system sends out the invite to join the community group 125 to the users 120 who have been invited to join the community group 125.

At operation 1325, a user 120 who has been invited to join the community group 125 by the community group admin 150 decides whether to accept the invitation to join the community group 125 or not. If at operation 1325, the invited user 120 decides to accept the invitation to join the community group 125, then at operation 1330, the system adds the user 120 as a member of the community group 125 and assigns the role within the community group 125 based on the role that was specified in the invitation. Also, at operation 1330 the CommunityValue of the community group 125 equivalent to the group joining CommunityValue is created and assigned to the user 120 by the system, which results in the user's 120 CommunityValue balance of the community group 125 increasing by value of the newly created Community Value.

Also, at operation 1330 in some embodiments not all, a percentage of the group joining CommunityValue is computed and is used to create CommunityValue of the community group 125 (community group being the group where user is being added), with amount set as the computed value, and this newly created CommunityValue is then assigned to the community enabler 187 by the system, which results in the community enabler's 187 CommunityValue balance of the community group 125 increasing by value of the newly created Community Value.

In certain embodiments (but not all) the group joining CommunityValue is set by the community group admin 150 for a community group 125. In certain other embodiments (but not all) the group joining CommunityValue is set by the system admin 185.

If at operation 1325, the invited user 120 decides not to accept the invitation to join the community group 125, then at operation 1335 the invited user 120 can provide the reason for rejecting the invitation if he desires to do so.

At operation 1340, information regarding the rejection of invitation to join the community group 125 is made available to the community group admin 150 along with rejection reason if any.

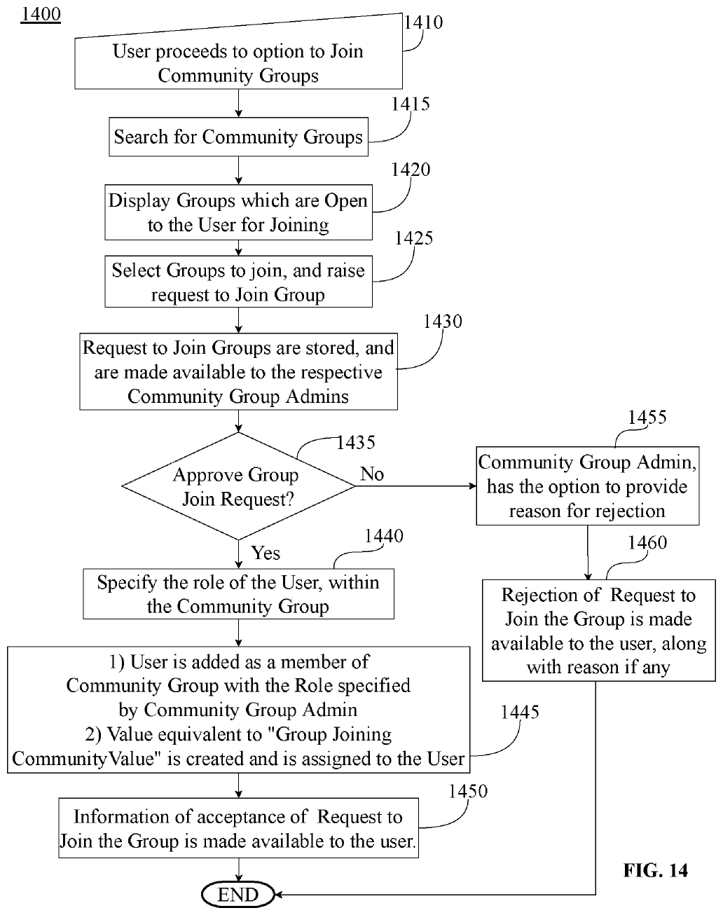

FIG. 14 shows a flow diagram of an exemplary embodiment 1400 of the present invention which shows a possible implementation, not all, of the way in a which a user 120 is able to join a community group 125 by raising a request to join a group.

At operation 1410, the user 120 proceeds to the option to join community groups.

At operation 1415, the user 120 is able to search for community groups 125 that he can join.

At operation 1420, the system displays the community groups 125 which are which are open to the user 120 for joining.

At operation 1425, the user 120 is able to select community groups 125 which he wishes to join and raise request to join his selected community groups 125.

At operation 1430, the request to join selected community groups 125 are stored and are made available to the respective community group admin 150 by the system.

At operation 1435, a community group admin 150 of a selected community group 125 that the user 120 wants to join, decides whether to accept the request to join the community group 125 by the user 120 or not. If at operation 1435 the community group admin 150 decides to accept the request to join the community group 125 by the user 120, then at operation 1440 the community group admin 150 specifies the role that the user 120 will be assigned within the community group 125.

At operation 1445, the system adds the user 120 as a member of the community group 125 and assigns the role within the community group 125 based on the role specified by the community group admin 150. Also, at operation 1445 the CommunityValue of the community group 125 equivalent to the group joining CommunityValue is created and assigned to the user 120 by the system, which results in the user's 120 CommunityValue balance of the community group 125 increasing by value of the newly created CommunityValue.

Also, at operation 1445 in some embodiments not all, a percentage of the group joining CommunityValue is computed and is used to create CommunityValue of the community group 125 (community group being the group where user is being added), with amount set as the computed value, and this newly created CommunityValue is then assigned to the community enabler 187 by the system, which results in the community enabler's 187 CommunityValue balance of the community group 125 increasing by value of the newly created CommunityValue.

In certain embodiments (but not all) the group joining CommunityValue is set by the community group admin 150 for a community group 125. In certain other embodiments (but not all) the group joining CommunityValue is set by the system admin 185.

At operation 1450, information regarding the acceptance of request to join the community group 125 is made available to the user 120.

If at operation 1435 the community group admin 150 decides not to accept the request to join the community group 125 by the user 120, then at operation 1455 the community group admin 150 can provide the reason for rejecting the request to join if he desires to do so.

At operation 1460, information regarding the rejection of request to join the community group 125 is made available to the user 120 along with rejection reason if any.

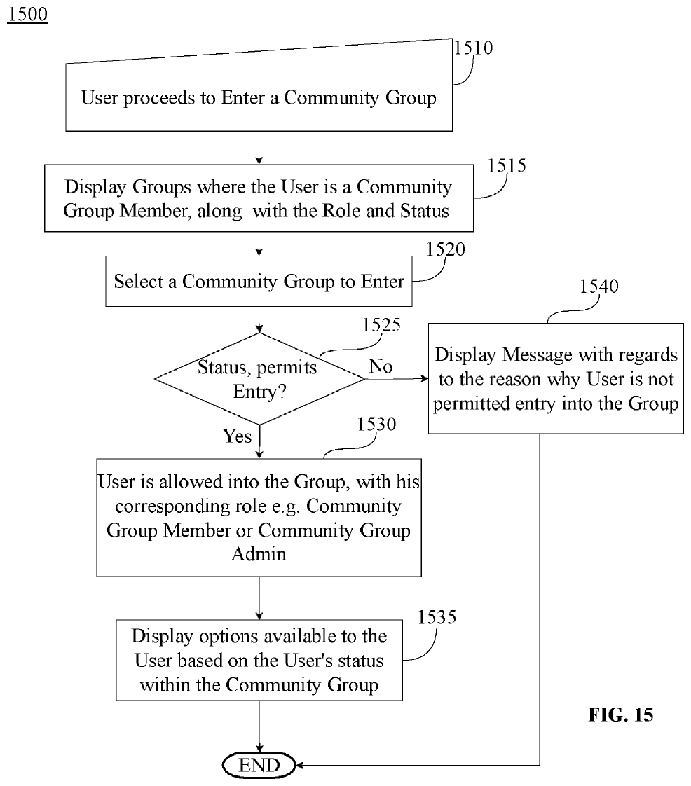

FIG. 15 shows a flow diagram of an exemplary embodiment 1500 of the present invention which shows a possible implementation, not all, of the way in a which a user 120 is able to enter a community group 125.

At operation 1510, the user 120 proceeds to the option to enter a community group.

At operation 1515, the system displays the community groups 125 in which the user 120 is a community group member 160. Also, at operation 1515 the role and status of the user 120 within each of the community groups 125 is displayed.

At operation 1520, the user 120 is able to select a community group 125 which he wishes to enter.

At operation 1525, the system checks to see if the status of the user 120 within the selected community group 125 permits the user to enter the community group 125 or not. If at operation 1525, the system determines that the status of the user 120 with respect to the selected community group 125 permits the user to enter the community group 125, then at operation the 1530 the user 120 is allowed to enter the community group 125 with his allocated role.

At operation 1535 based on the user's 120 status with respect to the community group 125, the system displays the options available to the user 120 within the community group 125.

If at operation 1525, the system determines that the status of the user 120 within the selected community group 125 does not permit the user to enter the community group 125, then at operation the 1540 the user 120 is displayed a message indicating that the user 120 is not permitted to enter the community group 125 along with the reason for the same.

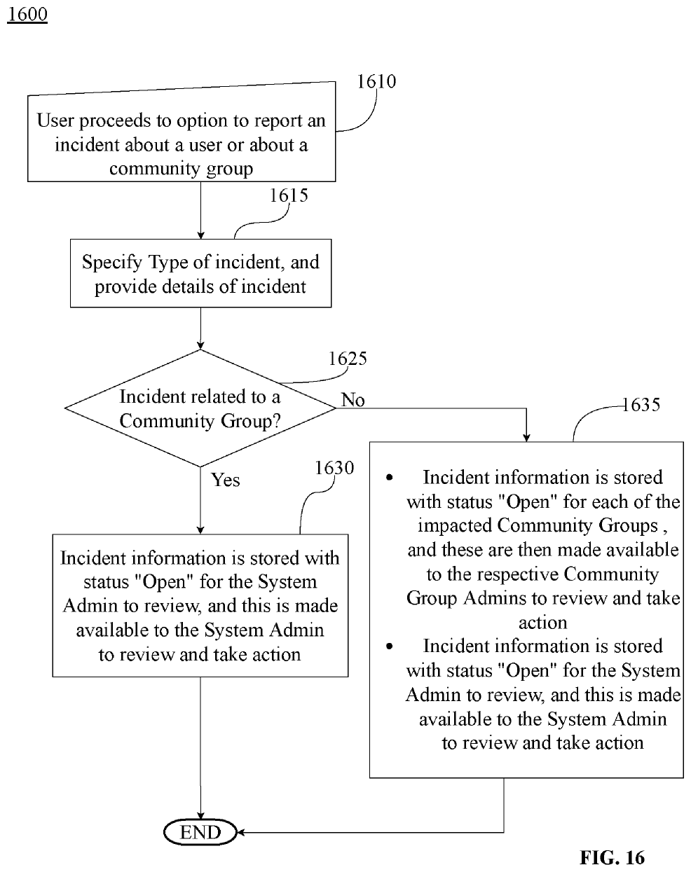

FIG. 16 shows a flow diagram of an exemplary embodiment 1600 of the present invention which shows a possible implementation, not all, of the way in a which a user 120 is either able to report an incident about a user 120 or about a community group 125.

At operation 1610, the user 120 proceeds to the option to report an incident about a user 120 or about a community group 125.

In some embodiments not all the option to report an incident about a user 120 is present at the point where incident has occurred, for example if a user 120 has done misconduct in providing a barter offer, then the incident of misconduct for the user 120 can be raised when the barter offer is viewed. In certain embodiments not all, the incident about a user 120 can be raised by searching for the user 120 and reporting the incident.

In some embodiments not all the option to report an incident about a community group 125 is present at a point where the community group 125 is displayed as part of a list, for example the incident related to misconduct of a community group 125 can be provided by a user 120 when the community group 125 is listed to the user 120 for entry into the community group 125.

At operation 1615, the user 120 specifies the type of incident (for example, misconduct by a user 120, wrongful suspension of a user 120), and provide details of the incident.

At operation 1625, the system checks to see if the incident being reported is related to a community group 125 or not. If at operation 1625, the system determines that the incident being reported is about a community group 125, then at operation 1630 the incident information is stored with status “Open” for the system admin 185 to review, and this is made available to the system admin 185 to review and take appropriate action.

If at operation 1625, the system determines that the incident being reported is not related to a community group 125 i.e., the incident being reported is related to a user 120, then at operation 1635 the incident information is stored with status “Open” for each of the impacted community groups 125 (i.e., community groups 125 where the user 120 related with the incident is a community group member 160), and these are then made available to the respective community group admins 150 to review and take action. Also, at operation 1635 incident information is stored with status “Open” for the system admin 185 to review, and this is made available to the system admin 185 to review and take appropriate action.

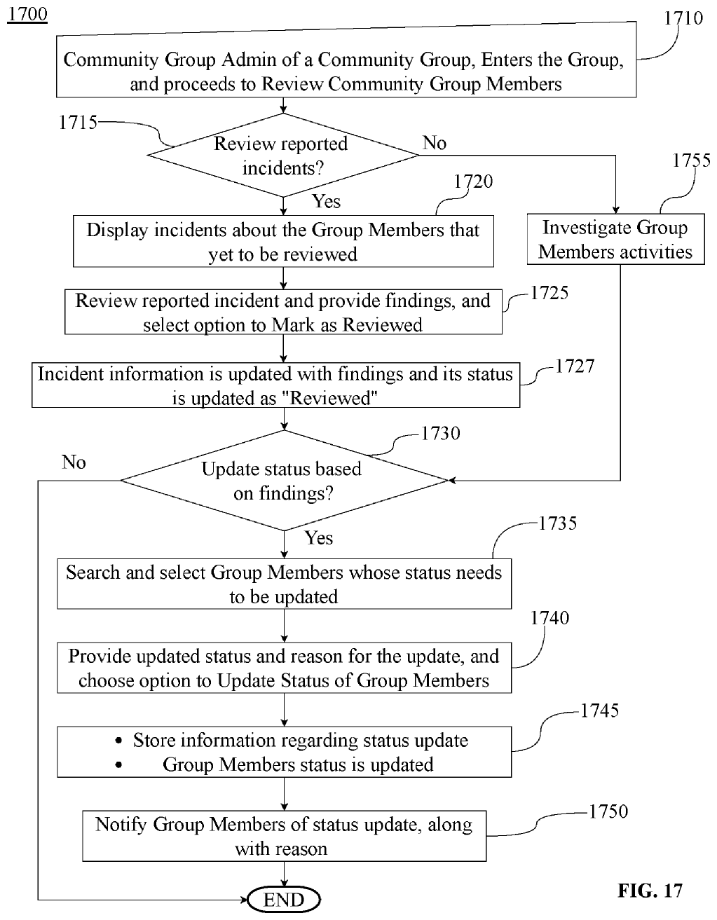

FIG. 17 shows a flow diagram of an exemplary embodiment 1700 of the present invention which shows a possible implementation, not all, of the way in a which a community group admin 150 of a community group 125 is able to update the status of community group members 160 with respect to the community group 125.

At operation 1710, the community group admin 150 of a community group 125 of a community group 125 enters the community group 125 and proceeds to option to review activities of community group members 160.

At operation 1715, the community group admin 150 decides if he wishes to review the incidents reported by users 120 about the community group members 160 or not. If at operation 1715 the community group admin 150 decides that he wishes to review the incidents reported by users 120 about the community group members 160, then at operation 1720 the system displays incidents with status “Open” that have been raised about the community group members 160 and that are available to the community group admin 150 for review.

At operation 1725, the community group admin 150 reviews an incident with status “Open” that have been raised about the community group members 160 and that are available to the community group admin 150 for review, and the community group admin 150 provides his findings and chooses option to mark an incident as reviewed.

At operation 1727, the system updates the incident information with the findings and its status is updated as “Reviewed”.

At operation 1730, the community group admin 150 decides if he wants to update status of community group members 160, based on findings of the incident review or based on findings on the community group members 160 activities investigation, or not. If at operation 1730, the community group admin 150 decides that he wants to update status of community group members 160, then at operation 1735 the community group admin 150 searches and selects the community group members 160 whose status is to be updated.

At operation 1740, the community group admin 150 specifies the new status that is to be used to update the status of the selected community group members 160, and provides reason for the status update, and chooses option to update status of community group members. In some embodiments, not all, the status could be updated to indicate suspension of the community group member 160 from certain activities within the community group 125. In some embodiments not all, the status could be updated to indicate revocation of suspension of the community group member 160 from certain activities within the community group 125.

At operation 1745, the system stores the information regarding the status update. Also, at operation 1745 the system updates each of the community group members 160 status with respect to the community group 125 to the new status.

At operation 1750, the system notifies the impacted community group members 160 of the status update, along with reason for the status update.

If at operation 1715 the community group admin 150 decides that he does not wish to review the incidents reported by users 120 about the community group members 160, then at operation 1755 the community group admin 150 investigates community group members 160 activities within the community group 125 for potential incidents.

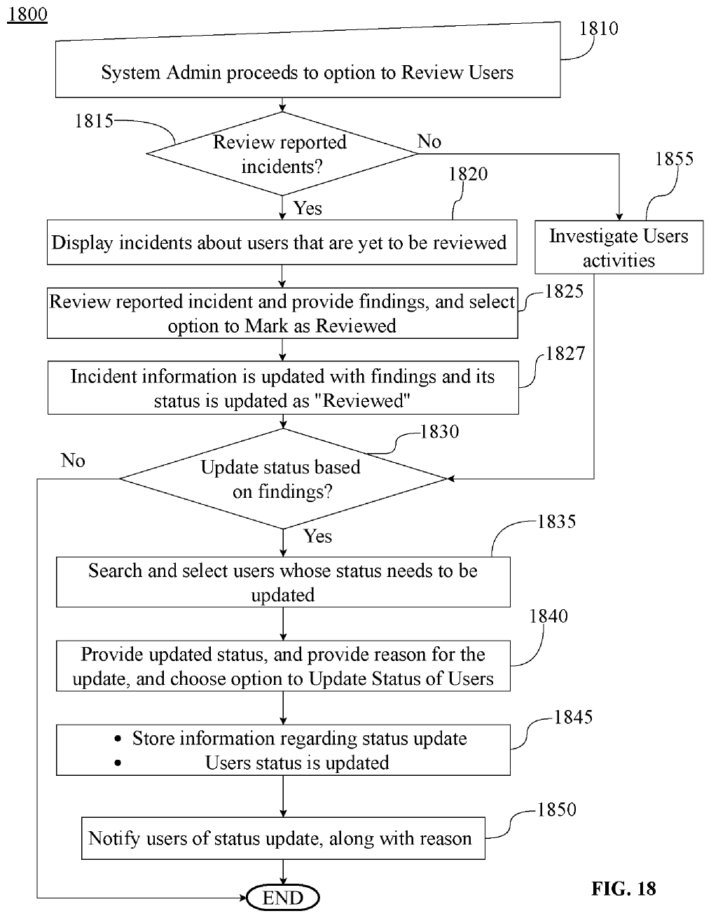

FIG. 18 shows a flow diagram of an exemplary embodiment 1800 of the present invention which shows a possible implementation, not all, of the way in a which a system admin 185 is able to update the status of a user 120 with respect to the system.

At operation 1810, the system admin 185 proceeds to option to review activities of users 120.

At operation 1815, the system admin 185 decides if he wishes to review the incidents reported about the users 120 or not. If at operation 1815 the system admin 185 decides that he wishes to review the incidents reported about the users 120, then at operation 1820 the system displays incidents with status “Open” that have been raised about the users 120 and that are available to the system admin 185 for review.

At operation 1825, the system admin 185 reviews an incident with status “Open” that have been raised about the users 120 and that are available to the system admin 185 for review, and the system admin 185 provides his findings and chooses option to mark incident as reviewed.

At operation 1827, the system updates the incident information with the findings and its status is updated as “Reviewed”.

At operation 1830, the system admin 185 decides if he wants to update status of users 120, based on findings of the incident review or based on findings on the users 120 activities investigation, or not. If at operation 1830, the system admin 185 decides that he wants to update status of users 120, then at operation 1835 the system admin 185 searches and selects the users 120 whose status is to be updated.

At operation 1840, the system admin 185 specifies the new status that is to be used to update the status of the selected users 120, and provides reason for the status update, and chooses option to update status of users. In some embodiments, not all, the status could be updated to indicate suspension of the users 120 from certain activities within the system. In some embodiments, not all, the status could be updated to indicate revocation of suspension of the users 120 from certain activities within the system.

At operation 1845, the system stores the information regarding the status update. Also, at operation 1845 the system updates each of the users 120 status, with respect to the system, to the new status.

At operation 1850, the system notifies the impacted users 120 of the status update, along with reason for the status update.

If at operation 1815 the system admin 185 decides that he does not wish to review the incidents reported about the users 120, then at operation 1855 the system admin 185 investigates users 120 activities within the system for potential incidents.

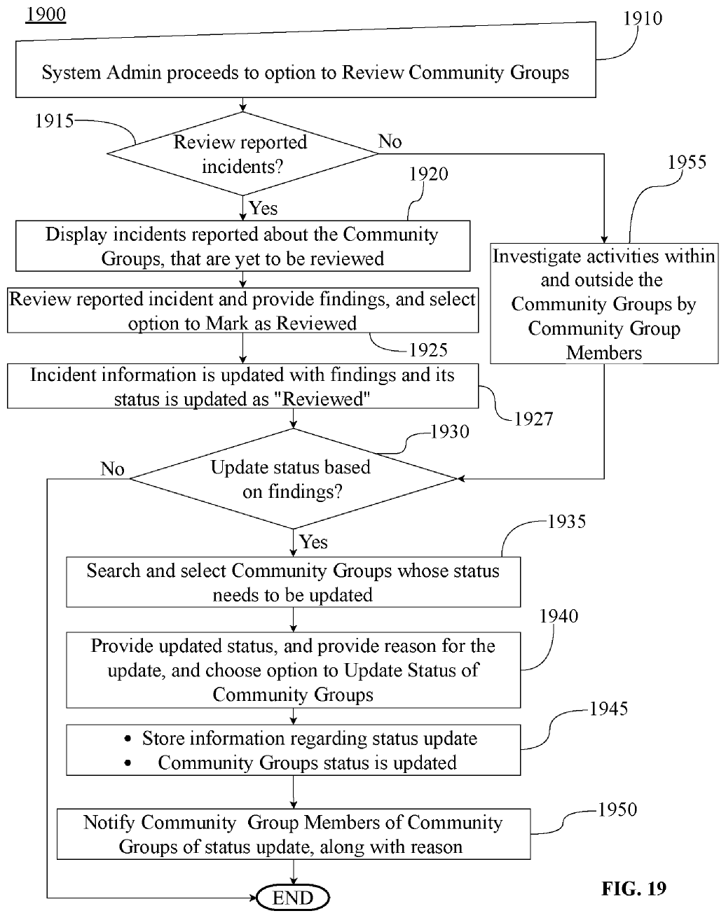

FIG. 19 shows a flow diagram of an exemplary embodiment 1900 of the present invention which shows a possible implementation, not all, of the way in a which a system admin 185 is able to update the status of a community group 125 with respect to the system.

At operation 1910, the system admin 185 proceeds to option to review activities of community groups 125.

At operation 1915, the system admin 185 decides if he wishes to review the incidents reported about the community groups 125 or not. If at operation 1915 the community group admin 150 decides that he wishes to review the incidents reported about the community groups 125, then at operation 1920 the system displays incidents with status “Open” that have been raised about the community groups 125 and that are available to the system admin 185 for review.

At operation 1925, the system admin 185 reviews an incident with status “Open” that have been raised about the community groups 125 and that are available to the system admin 185 for review, and the system admin 185 provides his findings and chooses option to mark incident as reviewed.

At operation 1927, the system updates the incident information with the findings and its status is updated as “Reviewed”.

At operation 1930, the system admin 185 decides if he wants to update status of the community groups 125, based on findings of the incident review or based on findings of the investigation on activities of the community group members 160 of the community groups 125, or not. If at operation 1930, the system admin 185 decides that he wants to update status of community groups 125, then at operation 1935 the system admin 185 searches and selects the community groups 125 whose status is to be updated.

At operation 1940, the system admin 185 specifies the new status that is to be used to update the status of the selected community groups 125, and provides reason for the status update, and chooses option to update status of community groups. In some embodiments, not all, the status could be updated to indicate suspension of the community groups 125 (which in turn are effectively placed on the community group members 160) from certain activities within the system. In some embodiments, not all, the status could be updated to indicate revocation of suspension of the community groups 125 (which in turn are effectively placed on the community group members 160) from certain activities within the system.

At operation 1945, the system stores the information regarding the status update.

Also, at operation 1945 the system updates each of the community groups 125 status to the new status.

At operation 1950, the system notifies the community group members 160 of the impacted community groups 125 of the status update, along with reason for the status update.

If at operation 1915 the system admin 185 decides that he does not wish to review the incidents reported about the community groups 125, then at operation 1955 the system admin 185 investigates activities that took place within the community groups 125 as well as activities that took place outside the community groups 125 by the community group members 160 for potential incidents.

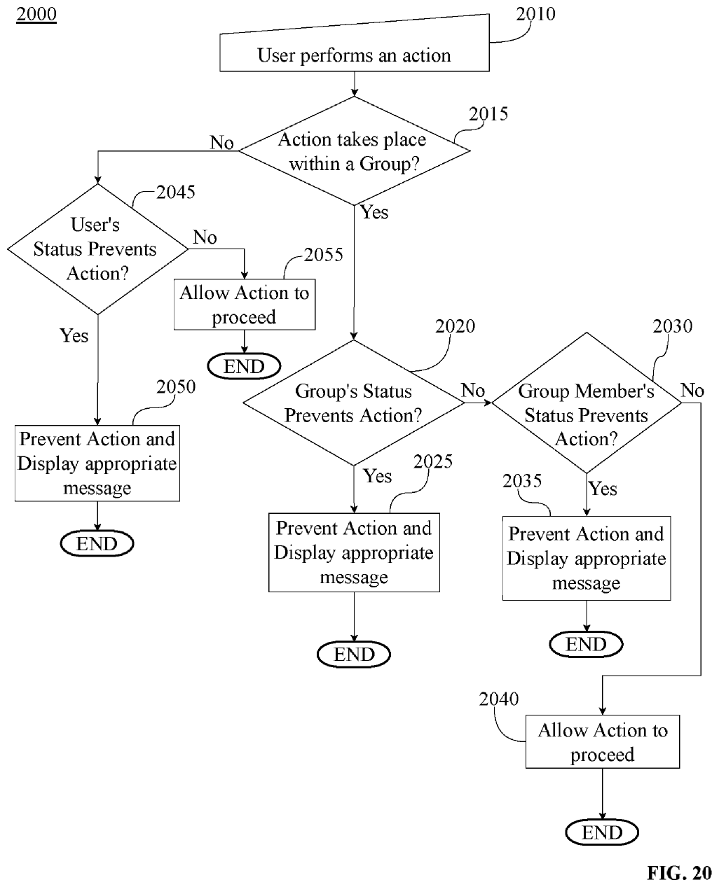

FIG. 20 shows a flow diagram of an exemplary embodiment 2000 of the present invention which shows a possible implementation, not all, of the way in a which the system prevents actions by users 120 based on the user's and the community group's status.

At operation 2010, a user 120 proceeds to perform an action in the system.

At operation 2015 the system checks to see if the user's 120 action takes place within a community group 125 or not, i.e., the system checks to see if the user 120 is performing the action after entering (or while trying to enter) a community group 125 or not. If at operation 2015 the system determines that the user's 120 action took place within a community group 125, then at operation 2020 the system checks to see if the community group's 125 status prevents the action or not.

If at operation 2020 the system determines that the community group's 125 status prevents the action, then at operation 2025 the system prevents the action from occurring and displays appropriate message to the user 120 with regards to why the action is not permitted.

If at operation 2020 the system determines that the community group's 125 status does not prevent the action, then at operation 2030 the system checks to see if the user's 120 status with respect to the community group 125 as a community group member 160 prevents the action or not.

If at operation 2030 the system determines that the user's 120 status with respect to the community group 125 as a community group member 160 prevents the action, then at operation 2035 the system prevents the action from occurring and displays appropriate message to the user 120 with regards to why the action is not permitted.

If at operation 2030 the system determines that the user's 120 status with respect to the community group 125 as a community group member 160 does not prevent the action, then at operation 2040 the action is allowed to proceed by the system.

If at operation 2015 the system determines that the user's 120 action took place not within a community group 125, then at operation 2045 the system checks to see if the user's 120 status, with respect to the system, prevents the action or not.

If at operation 2045 the system determines that the user's 120, status with respect to the system, prevents the action, then at operation 2050 the system prevents the action from occurring and displays appropriate message to the user 120 with regards to why the action is not permitted.

If at operation 2045 the system determines that the user's 120, status with respect to the system, does not prevent the action, then at operation 2055 the action is allowed to proceed by the system.

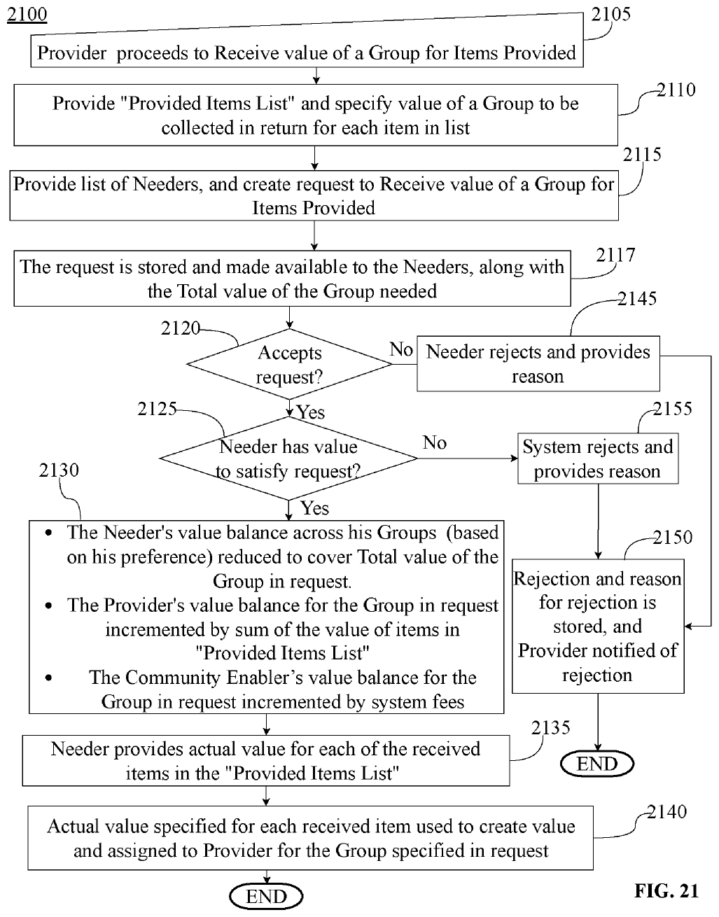

FIG. 21 shows a flow diagram of an exemplary embodiment 2100 of the present invention which shows a possible implementation, not all, of the way in a which a provider 130 is able to receive value in terms of CommunityValue of a specific community group 125 for items provided.

At operation 2105, a provider 130 proceeds to the option to receive value in term of CommunityValue of a community group 125 for items provided.

At operation 2110, the provider 130 provides the “Provided Items List” which is a list of items representing goods and services that is being provided by him, along with the CommunityValue of a specific community group 125 that he would like to be collected in return for each of the items in the “Provided Items List”.

At operation 2115, the provider 130 provides the list of needers 135 to whom the request should be sent and chooses the option to create a request to receive CommunityValue of a specific community group 125 for items provided.

At operation 2117, the system stores the request to receive CommunityValue of a specific community group 125 for items provided and makes this request available to the list of needers 135 that were specified in operation 2115, along with the total CommunityValue of the specific community group 125 that would be collected from needer 135 if the request is accepted by the needer 135. In some embodiments, not all, the total CommunityValue of the specific community group 125 that would be collected from needer 135 is set as the sum of the CommunityValue of the specific community group 125 to be collected for each of the items in the “Provided Items List”, plus any system fees expressed in terms of CommunityValue of the specific community group 125.

At operation 2120, a needer 135 decides if he wants to accept the request, made by the provider 130, to receive CommunityValue of the specific community group 125 for items provided or not. If at operation 2120, a needer 135 decides that he wants to accept the request, then at operation 2125 the system determines if the needer 135 has sufficient CommunityValue balance across various community groups 125 to cover the total CommunityValue of the specific community group 125 specified in request or not. In some embodiments, not all, the checks are carried out starting with the needer's 135 CommunityValue balance in the specific community group 125 present in the request, followed by needers CommunityValue balance in other community group 125 based on needers 135 preference (after each of the CommunityValue balance in other community groups 125 has been converted to the CommunityValue of the specific community group 125 present in the request). In some embodiments, not all, if conversion of CommunityValue is required then the rate to be used in the conversion process is computed as defined in 2300.

If at operation 2125 the systems determines that the needer 135 has sufficient CommunityValue balance across various community groups 125 to cover the total CommunityValue of the specific community group 125 specified in request that would be collected for the request, then at operation 2130 the needer's CommunityValue balance across various community groups 125 is reduced by the system to cover the total CommunityValue of the community group 125 specified in request. In some embodiments, not all, the needer's 135 CommunityValue balance reduction starts with the specific community group 125 present in the request, followed by reduction of needer's 135 CommunityValue balance in other community group 125 based on needers 135 preference (after the balance has been converted to the CommunityValue of the specific community group 125 present in the request). In some embodiments, not all, if conversion of CommunityValue is required then the rate to be used in the conversion process is computed as defined in 2300.

Also, at operation 2130 the system increments the provider's 130 CommunityValue balance in the specific community group 125 present in the request by the sum of the CommunityValue of the specific community group 125 in the “Provided Items List”. Also, at operation 2130 the system increments the community enabler's 187 CommunityValue balance of the specific community group 125 present in the request, by the system fees.

At operation 2135 the needer 135 provides the actual value expressed in terms of actual CommunityValue for each of the items in the “Provided Items List” that he has received from the provider 130.

At operation 2140 the actual CommunityValue of specified for each item in the “Provided Items List” that has been received by the needer 135, is used to create CommunityValue of the specific community group 125 specified in request and this newly created CommunityValue is then assigned to the provider 130 by the system, which results in the provider's 130 CommunityValue balance of the specific community group 125 specified in request increasing by value of the newly created Community Value.

Also, at operation 2140 in some embodiments not all, a percentage of actual CommunityValue specified for each item in the “Provided Items List” is computed and is used to create CommunityValue of the community group 125 (community group being the group where the request was raised), with amount set as the computed value, and this newly created CommunityValue is then assigned to the community enabler 187 by the system, which results in the community enabler's 187 CommunityValue balance of the community group 125 increasing by value of the newly created Community Value.

If at operation 2120, a needer 135 decides that he does not want to accept the request, then at operation 2145 the needer 135 rejects the request and provides reason for rejection of the request.

At operation 2150, the system stores the rejection and the reason for rejection of the request and notifies the provider 130 of the rejection and the reason for rejection.

If at operation 2125 the systems determines that the needer 135 does not have sufficient CommunityValue balance across various community groups 125 to cover the total CommunityValue of the specific community group 125 specified in the request, then at operation 2155 the system rejects the request and sets the reason for rejection to indicate insufficient CommunityValue funds.

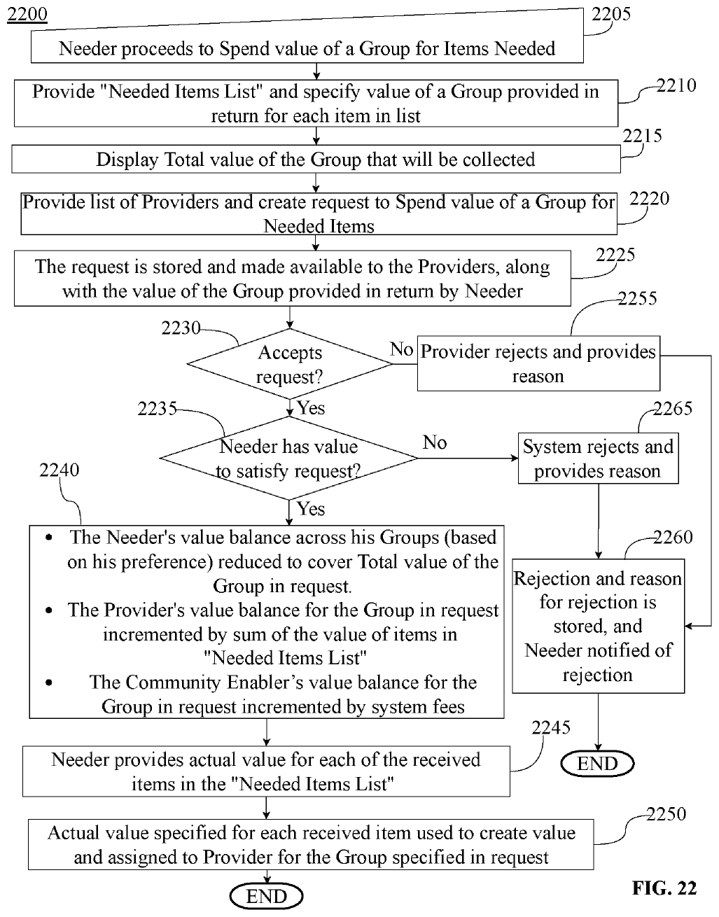

FIG. 22 shows a flow diagram of an exemplary embodiment 2200 of the present invention which shows a possible implementation, not all, of the way in a which a needer 135 is able to spend value in terms of CommunityValue of a specific community group 125 for items that are needed by him.

At operation 2205, a needer 135 proceeds to the option to spend value in term of CommunityValue a community group 125 for needed items.

At operation 2210, the needer 135 provides the “Needed Items List” which is a list of items representing goods and services that are needed by him, along with the CommunityValue of a specific community group 125 that he would like to provide in return for each of the items in the “Needed Items List”.

At operation 2215, the system displays total CommunityValue of the specific community group 125 in the request (inclusive of system fees), that will be collected from the needer each time a provider 130 accepts a request to spend CommunityValue the specific community group 125. In some embodiments, not all, the total CommunityValue of the specific community group 125 in the request that would be collected from needer 135 is set as the sum of the CommunityValue of the specific community group 125 in the request that would be provided in return to the provider 130 for each of the items in the “Needed Items List”, plus any system fees expressed in terms of CommunityValue of the specific community group 125 in the request.

At operation 2220, the needer 135 provides the list of providers 130 to whom the request should be sent and chooses the option to create a request to spend CommunityValue of a specific community group 125 for needed items.

At operation 2225, the system stores the request to spend CommunityValue of a specific community group 125 for needed items and makes this request available to the list of providers 130 that were specified in operation 2220, along with the CommunityValue of the specific community group 125 that would be provided in return to the provider 130 by the needer 135 if the request is accepted by the provider 130.

At operation 2230, a provider 130 decides if he wants to accept the request, made by the needer 135, to spend CommunityValue of a specific community group 125 for needed items or not. If at operation 2230, a provider 130 decides that he wants to accept the request, then at operation 2235 the system determines if the needer 135 has sufficient CommunityValue balance across various community groups 125 to cover the total CommunityValue of the specific community group 125 specified in request or not. In some embodiments, not all, the checks are carried out starting with the needer's 135 CommunityValue balance in the specific community group 125 present in the request, followed by needers CommunityValue balance in other community group 125 based on needers 135 preference (after each of the CommunityValue balance in other community groups 125 has been converted to the CommunityValue of the specific community group 125 present in the request). In some embodiments, not all, if conversion of CommunityValue is required then the rate to be used in the conversion process is computed as defined in 2300.

If at operation 2235 the systems determines that the needer 135 has sufficient CommunityValue balance across various community groups 125 to cover the total CommunityValue of the specific community group 125 specified in request that would be deducted for the request, then at operation 2240 the needer's CommunityValue balance across various community groups 125 is reduced by the system to cover the total CommunityValue of the community group 125 specified in request. In some embodiments, not all, the needer's 135 CommunityValue balance reduction starts with the specific community group 125 present in the request, followed by reduction of needer's 135 CommunityValue balance in other community group 125 based on needers 135 preference (after the balance in other community group 125 has been converted to the CommunityValue of the specific community group 125 present in the request). In some embodiments, not all, if conversion of CommunityValue is required then the rate to be used in the conversion process is computed as defined in 2300.

Also, at operation 2240 the system increments the provider's 130 CommunityValue balance in the specific community group 125 present in the request by the sum of the CommunityValue of the specific community group 125 in the “Needed Items List”. Also, at operation 2240 the system increments the community enabler's 187 CommunityValue balance of the specific community group 125 present in the request, by the system fees.

At operation 2245 the needer 135 provides the actual value in terms of CommunityValue for each of the items in the “Needed Items List” that he has received from the provider 130.

At operation 2250 the actual CommunityValue of specified for each item in the “Needed Items List” that has been received by the needer 135, is used to create CommunityValue of the specific community group 125 specified in request and this newly created CommunityValue is then assigned to the provider 130 by the system, which results in the provider's 130 CommunityValue balance of the specific community group 125 specified in request increasing by value of the newly created Community Value.

Also, at operation 2250 in some embodiments not all, a percentage of actual CommunityValue specified for each item in the “Needed Items List” is computed and is used to create CommunityValue of the community group 125 (community group being the group where the request was raised), with amount set as the computed value, and this newly created CommunityValue is then assigned to the community enabler 187 by the system, which results in the community enabler's 187 CommunityValue balance of the community group 125 increasing by value of the newly created CommunityValue.

If at operation 2230, a provider 130 decides that he does not want to accept the request, then at operation 2255 the provider 130 rejects the request and provides reason for rejection of the request.

At operation 2260, the system stores the rejection and the reason for rejection of the request and notifies the needer 135 of the rejection and the reason for rejection.

If at operation 2235 the systems determines that the needer 135 does not have sufficient CommunityValue balance across various community groups 125 to cover the total CommunityValue of the specific community group 125 specified in the request, then at operation 2265 the system rejects the request and sets the reason for rejection to indicate insufficient CommunityValue funds.

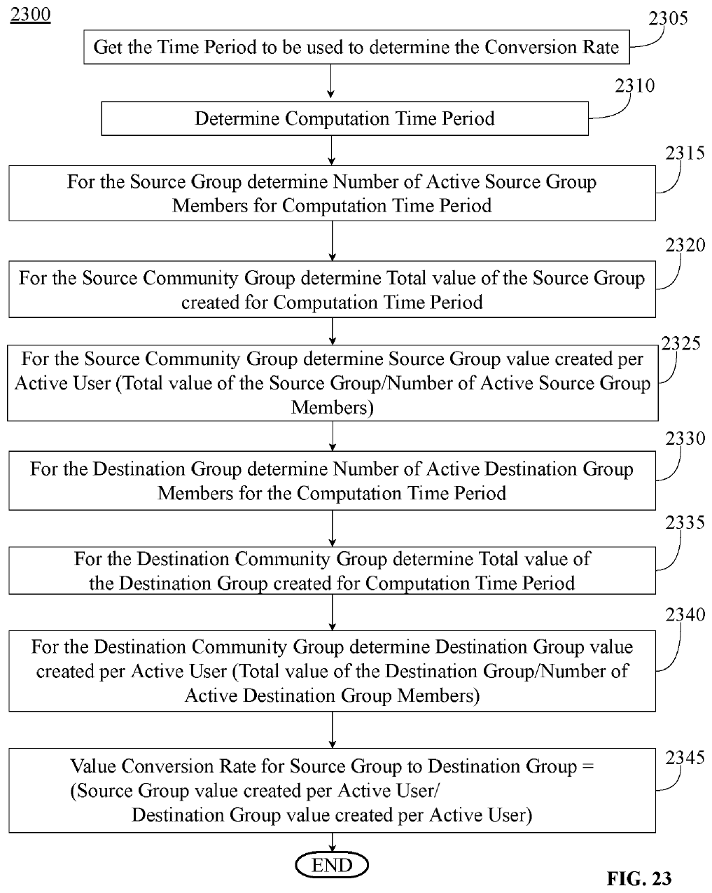

FIG. 23 shows a flow diagram of an exemplary embodiment 2300 of the present invention which shows a possible implementation, not all, of the way in a which the system computes the conversion rate to be used in the conversion process when converting CommunityValue from a source community group 125 to the CommunityValue of a destination community group 125.

At operation 2305, the system gets the “Time Period” to be used to determine the conversion rate. In some embodiments, not all, the “Time Period” is expressed in days e.g., 365 days

At operation 2310, the system determines the “Computation Time Period” which is the time between a start time and an end time that will be used for computation. In some embodiments, not all, the start time may be set as current time minus the “Time Period”, and the end time may be set as the current time.

At operation 2315, for the source community group 125 the system determines the number of source community group members 160 who are active, during the “Computation Time Period”. In some embodiments not all, users who are not suspended from the community group 125 are considered as active. In certain other embodiments not all, users who have some activity in the “Computation Time Period” are considered active.

At operation 2320, for the source community group 125 the system determines the total CommunityValue of the source community group 125 that got created during “Computation Time Period”.

At operation 2325, for the source community group 125 the system determines the source community group CommunityValue created per active user, which is equal (total CommunityValue of the source community group 125/number of source community group members 160 who are active)

At operation 2330, for the destination community group 125 the system determines the number of destination community group members 160 who are active, during the “Computation Time Period”. In some embodiments not all, users who are not suspended from the community group 125 are considered as active. In certain other embodiments not all, users who have some activity in the “Computation Time Period” are considered active.

At operation 2335, for the destination community group 125 the system determines the total CommunityValue of the destination community group 125 that got created during “Computation Time Period”.

At operation 2340, for the destination community group 125 the system determines the destination community group CommunityValue created per active user, which is equal (total CommunityValue of the destination community group 125/number of destination community group members 160 who are active)

At operation 2345, the system determines the CommunityValue conversion rate for converting CommunityValue of the source community group to the CommunityValue of destination community group as equal to (source community group CommunityValue created per active user/destination community group CommunityValue created per active user)

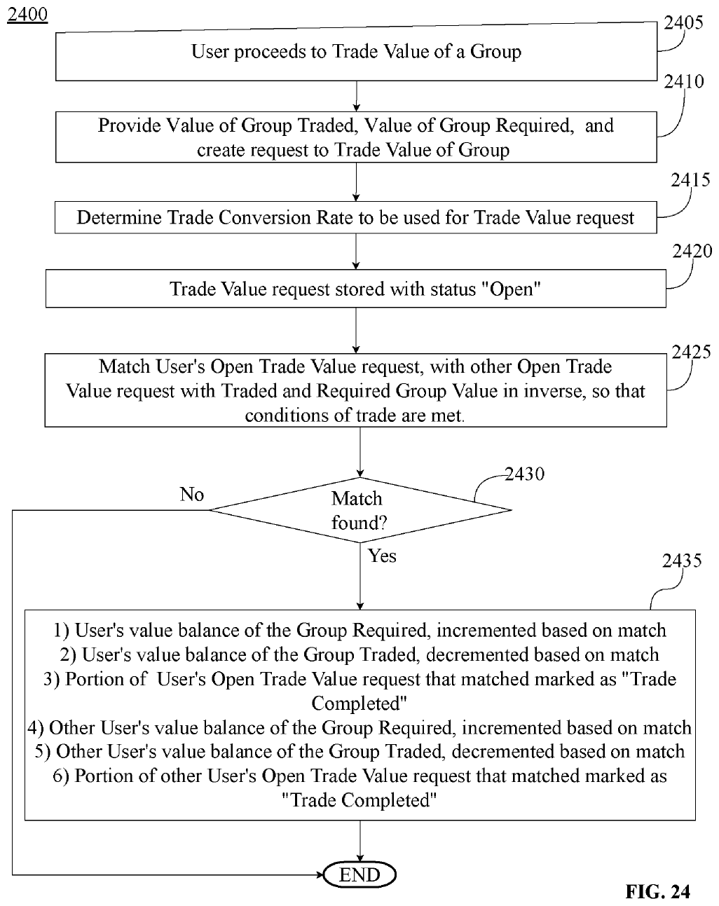

FIG. 24 shows a flow diagram of an exemplary embodiment 2400 of the present invention which shows a possible implementation, not all, of the way in a which a user 120 is able to trade the CommunityValue of a community group 125 to obtain the CommunityValue of another community group 125

At operation 2405, the user 120 proceeds to the option to trade the CommunityValue of a community group 125.

At operation 2410, the user 120 provides the CommunityValue of the community group 125 that is traded by him. Also, at operation 2410 the user 120 provides the CommunityValue of the community group 125 that is required by him, and the user 120 chooses the option to raise trade CommunityValue request.

At operation 2415, the system determines the trade conversion rate that is to be used for the trade CommunityValue request. In some embodiments, not all, trade conversion rate is set equal to (CommunityValue of the community group 125 that is required/CommunityValue of the community group 125 that is traded)

At operation 2420, the system stores the trade CommunityValue request with status “Open” along with information on the CommunityValue of the community group 125 that is required, the CommunityValue of the community group 125 that is traded, and the trade conversion rate to be used which in some embodiments not all is the minimum rate required for condition of trade to be met.

At operation 2425, the system finds the matches for user's 120 open trade CommunityValue request, by matching the same with other user's 120 open trade CommunityValue request which have the traded and required community group 125 in inverse, so that the conditions of trade of both parties open trade CommunityValue requests are met, for a portion or the entire user's 120 request.

At operation 2430, the system checks to determine if a portion (or all, which is the entire portion) of the user's 120 CommunityValue of the community groups 125 that is traded and required present in the user's 120 open trade CommunityValue request matches (i.e., conditions of trade of both parties requests are met) with another user's 120 open trade CommunityValue requests which have the traded and required community group 125 in inverse or not.

If at operation 2430 the system determines that a portion of the user's 120 open trade CommunityValue request matches with another user's 120 open trade CommunityValue request such that the conditions of trade of both parties are met, then at operation 2435, the user's 120 CommunityValue balance of the community group 125 that is required is incremented by the trade conversion rate present in the user's 120 trade CommunityValue request multiplied by the portion of the user's 120 CommunityValue of the community group 125 that is traded and that which got matched.

Also at operation 2435, the user's 120 CommunityValue of the community group 125 that is traded is decremented by the portion of the user's 120 CommunityValue of the community group 125 that is traded which got matched.

Also at operation 2435, the portion of the user's 120 open trade CommunityValue request that represents the portion of the user's 120 CommunityValue of the community group 125 that is traded and that which got matched is marked as “Trade Completed”, i.e., status is changed from “Open” to “Trade Completed”. For example, in some embodiments not all, if the user open trade request consisted of 100 CommunityValue of Group1 is traded for 200 CommunityValue of Group2, and in the current match 10 CommunityValue of Group1 found a match then the 10 CommunityValue of Group1 is traded for the user trade request will be marked as “Trade Completed” while the 90 CommunityValue of Group1 that is being traded will remain with status “Open”.

Also at operation 2435, the other user's 120 CommunityValue balance of the community group 125 that is required is incremented by portion of the user's 120 CommunityValue of the community group 125 that is traded and that which got matched.

Also at operation 2435, the other user's 120 CommunityValue of the community group 125 that is traded is decremented by trade conversion rate present in the user's 120 trade CommunityValue request multiplied by the portion of the user's 120 CommunityValue of the community group 125 that is traded and that which got matched.

Also at operation 2435, the portion of the other user's 120 open trade CommunityValue request that represents the portion of the other user's 120 CommunityValue of the community group 125 that is traded and that which got matched is marked as “Trade Completed”, i.e., status is changed from “Open” to “Trade Completed”.

Also at operation 2435, in some embodiments not all, the difference between (1/trade conversion rate of the other user's 120 open trade CommunityValue request) and the (trade conversion rate of the user's 120 open trade CommunityValue request) is multiplied by the portion of the user's 120 CommunityValue of the community group 125 that is traded and that which got matched and this is used to increment the community enabler's 187 CommunityValue balance of the specific community group 125 that was traded by the user 120.

Also at operation 2435, in some embodiments not all, a system fees in the form of a small amount of CommunityValue of the community group 125 that was required by the users in the trade requests are collected from the users after the trade requests are executed, and this system fee is then used to increment the community enabler's 187 CommunityValue balances of the community groups 125 that were required by the users whose trade requests were executed.

1. A system, comprising of one or more processors; and memory storing executable instructions that, if executed by the one or more processors, configure the system to: communicate with users of the system using a device running a user interface,
allowing users to form groups and support each other by providing for each other's needs for goods and services through various options like charity, barter or by providing goods and services in exchange of something of value (including virtual currency which gets created based on value provided when user's needs are met).

2. A system of claim 1, wherein the users can form groups (also known as community groups), and members to a community group (also known as community group members) can be added via an invite being send to users or by users requesting to join the community group,
and wherein the community group members can raise and satisfy each other's charity and barter requests for goods and services,
and wherein the value of goods and services perceived by a community group member (which is also influenced by the way the goods and services were provided) is used to create a virtual currency (called CommunityValue associated with the community group) and wherein this virtual currency is assigned to the community group member who provided the goods and services.

3. A system of claim 2, wherein the community group members listing the goods and services needed by them in the form of charity needs or barter wanted list, or wherein the community group members listing the goods and services that can be provided by them in the form of charity supplies or barter trade list, can specify the estimated value in terms of estimated CommunityValue for the goods and services needed or provided by them.

4. A system of claim 2, wherein the community group members who have actually received goods and services either as part of a charity or a barter, can specify the actual value for the goods and services they received in terms of actual CommunityValue, and wherein a virtual currency related to the community group member's community group (also known as, CommunityValue of the community group) would be created with the amount of virtual currency created being set equal to the actual CommunityValue specified, and wherein the newly created virtual currency is assigned to the community group member who provided the goods and services (thereby giving the community group member who provided the goods and services, access to the newly created virtual currency).

5. A system of claim 2, wherein the community group members can message each other with respect to the goods and services needed or provided for as part of a charity or barter.

6. A system of claim 1, wherein the users are able to provide or receive goods and services from other users, in exchange for virtual currency associated with the CommunityValue of a specific community group, and wherein the user who actually received the goods and services can specify the actual value for the goods and services they received in terms of actual CommunityValue, and wherein a virtual currency related to the specific community group in the request (also known as, CommunityValue of the community group) would be created with the amount of virtual currency created being set equal to the actual CommunityValue specified, and wherein the newly created virtual currency is assigned to the user who provided the goods and services (thereby giving the user who provided the goods and services, access to the newly created virtual currency).

7. A system of claim 6, wherein if a user does not have access to CommunityValue of a specific community group required in exchange for goods and services, then an equivalent value of CommunityValue of community group/s he possess can be used by converting the CommunityValue of community group/s he possess into the CommunityValue of a specific community group required in exchange, and wherein the rate to be used for converting can be determined by various means for instance by considering the amount of CommunityValue of a community group that got created and the number of users of the community group.

8. A system of claims 3-4 and claim 6, wherein checks can be placed on the amount of estimated value in terms of estimated CommunityValue and actual value in terms of actual CommunityValue that can be specified with respect to a community group in concern, with respect to goods and services.

9. A system, comprising of one or more processors; and memory storing executable instructions that, if executed by the one or more processors, configure the system to: communicate with users of the system using a device running a user interface, wherein users can create trade virtual currency called CommunityValue related to one community group for CommunityValue related to another community group.

10. A system of claim 9, wherein system fees in the form of virtual currency CommunityValue of the community group that is required gets deducted from the users involved in trade requests that got executed, and wherein the system fees is then used to increment the community enabler's CommunityValue balances of the community groups that were required in the trade requests that got executed.

11. A system of claim 4 and claim 6, wherein additional virtual currency related to a specific community group gets created when the needs of users for goods and services are met, so that it can be assigned to the community enabler who ensures that the system is available to the users.

12. A system of claim 6, wherein system fees in the form of virtual currency CommunityValue of a community group gets deducted from the user whose needs are met as a part of a request where goods and services are obtained in exchange for virtual currency CommunityValue of the community group, and wherein the system fees is then used to increment the community enabler's virtual currency CommunityValue balance of the community group specified in the request.

13. A system of claims 1-12, and wherein the community group admins, the system admins, the community group admins, or the system itself can take appropriate actions to restrict or allow the activities of the users and community group members, and wherein the users of the system can report on misconduct or non-misconduct using the system, which are then made available to the admins.
